(19) United States
(12) Patent Application Publication
(10) Pub. No.: US 2018/0148670 A1
(43) Pub. Date: May 31, 2018

(54) DETERGENT COMPOSITION COMPRISING SUBTILASE VARIANTS

(71) Applicant: Henkel AG & Co. KGaA, Duesseldorf (DE)

(72) Inventors: Timothy O'Connell, Landsberg am Lech (DE); Susanne Tondera, Duesseldorf (DE); Hendrik Hellmuth, Darmstadt (DE); Thomas Weber, Dormagen (DE); Miguel Duarte Guilherme Pereira Toscano, Frederiksberg (DK); Vibeke Skovgaard Nielsen, Bagsvaerd (DK); Mikael Bauer, Malmo (SE)

(73) Assignee: Henkel AG & Co. KGaA, Duesseldorf (DE)

(21) Appl. No.: 15/577,352

(22) PCT Filed: Jun. 15, 2016
(86) PCT No.: PCT/EP2016/063705

§ 371 Date: Nov. 28, 2017

(30) Foreign Application Priority Data
Jun. 18, 2015 (EP) 15172635.3

(51) Int. Cl. C11D 3/386; C11D 17/06; C11D 17/04; C11D 11/00

(52) U.S. Cl. CPC C11D 3/38609; C11D 17/06; C11D 17/045; C11D 11/0023; C11D 3/38654; C11D 3/38645; C11D 3/38636

(57) ABSTRACT

The present disclosure relates to a detergent composition, such as laundry detergent compositions and dish wash compositions, including automatic dish wash compositions comprising subtilase variants. The present disclosure also relates to the use of said detergent compositions in a cleaning process such as laundry or hard surface cleaning. The present disclosure further relates to a method for removing a stain from a surface, which comprises contacting the surface with the detergent composition.

### CROSS-REFERENCE TO RELATED APPLICATION

This application is a U.S. National-Stage entry under 35 U.S.C. § 371 based on International Application No. PCT/EP2016/063705, filed Jun. 15, 2016 which was published under PCT Article 21(2) and which claims priority to European Application No. 15172635.3, filed Jun. 18, 2015, which are all hereby incorporated in their entirety by reference.

### REFERENCE TO A SEQUENCE LISTING

This application contains a Sequence Listing in computer readable form, which is incorporated herein by reference.

### TECHNICAL FIELD

The present disclosure relates to a detergent composition comprising subtilase variants, such as laundry detergent compositions and dish wash compositions, including automatic dish wash compositions. The present disclosure also relates to the use of said detergent compositions in a cleaning process such as laundry or hard surface cleaning. The present disclosure further relates to a method for removing a stain from a surface, which comprises contacting the surface with the detergent composition.

### BACKGROUND

In the detergent industry, enzymes have for many decades been implemented in washing formulations. Enzymes used in such formulations comprise amylases, cellulases, lipases, mannosidases, and proteases, as well as other enzymes or mixtures thereof. Commercially the most important enzymes are proteases.

An increasing number of commercially used proteases are protein engineered variants of naturally occurring wild type proteases Everlase®, Relase®, Ovozyme®, Polarzyme®, Liquanase®, Liquanase Ultra® and Kannase® (Novozymes A/S), Purafast®, Purafect OXP®, FN3®, FN4® and Excellase® (Genencor International, Inc.). Further, a number of variants are described in the art, such as in WO1996/034946, WO 2004/041979 and WO2000/037599 (Novozymes A/S) which describes subtilase variants exhibiting alterations relative to the parent subtilase in, e.g., wash performance, thermal stability, storage stability or catalytic activity. The variants are suitable for use in, e.g., cleaning or detergent compositions.

A number of subtilase variants have been described many of which have provided improved activity, stability, and solubility in different detergents.

However, various factors make further improvement of the proteases advantageous. Washing conditions such as temperature and pH change over time and many stains are still difficult to completely remove under conventional washing conditions. Despite intensive research in protease development there remains a need for proteases that have improved wash performance in detergent compositions compared to the parent subtilase.

### BRIEF DESCRIPTION OF THE DRAWINGS

FIG. 1 is an alignment of the amino acid sequences of subtilisin 309 (SEQ ID NO: 1) and subtilisin BPN′ (SEQ ID NO: 2), using the Needleman-Wunsch algorithm.

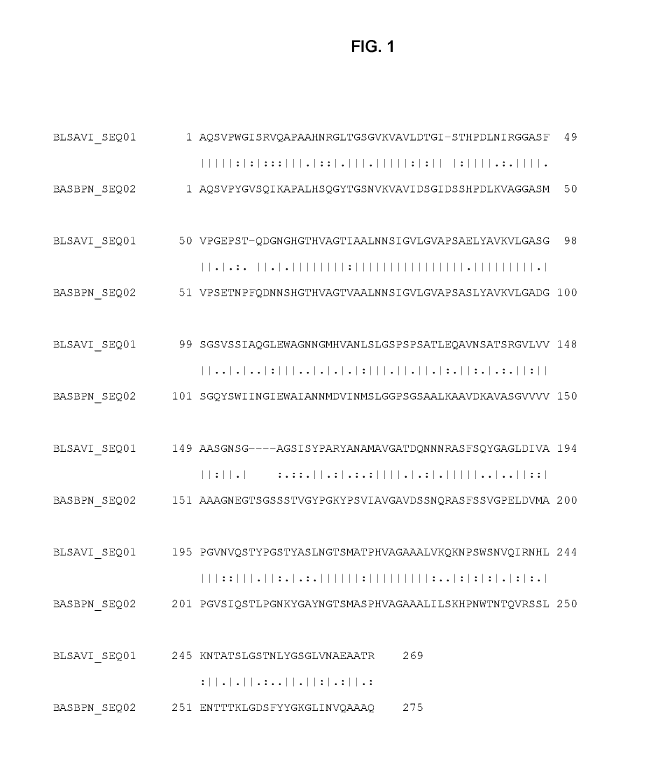

### BRIEF SUMMARY

A detergent composition including subtilase variants is provided herein. The subtilase variants include a set of alterations selected from the group of:

(a) X167A+R170S+A194P and one or more substitutions selected from the group of X59D, X62D, X76D, X104T, X120D, X133P, X141N, X156D, X163G, X209W, X228V, X230V, X238E X261D, and X262E;
(b) *99aE and one or more substitutions selected from the group of X21D, X59D, X101H, X120D, X156D, X163G, X194P, X195E, X209W, X238E, X256D, X261D, and X262E;
(c) X62D and one or more substitutions selected from the group of X101H, X104T, X156D, X163G, X170S, X170L, X209W, X238E, X245R and X262E;
(d) X62D+X245R+X248D and one or more substitutions selected from the group of X156D, X163G, X163K, X170S, X209W, and X262E;
(e) X170L, X170N, X170S and one or more substitutions selected from the group of X57P, X167A, X172E, X206E); and
(f) X99D and one or more substitutions selected from the group of *97aN, *98aA, X98T, X261D, and X262Q.
Further, (i) the positions correspond to the positions of the polypeptide of SEQ ID NO: 2, (ii) the variant has protease activity, and (iii) the variant has at least 60%, but less than 100% sequence identity to the polypeptide of SEQ ID NO: 1.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

The present disclosure relates to detergent compositions comprising subtilase variants having protease activity and comprising a set of alterations selected from the group of:

(a) X167A+R170S+A194P (e.g., Y167A+R170S+A194P) and one or more substitutions selected from the group of X59D (e.g., Q59D), X62D (e.g., N62D), X76D (e.g., N76D), X104T (e.g., V104T), X120D (e.g., H120D), X133P (e.g. A133P), X141N (e.g. S141N), X156D (e.g., S156D), X163G (e.g., S163G), X209W (e.g., Y209W), X228V (e.g. A228V), X230V (e.g. A230V), X238E (e.g., N238E), X261D (e.g., N261D), and X262E (e.g., L262E);
(b) *99aE and one or more substitutions selected from the group of X21D (e.g L21D), X59D (e.g., Q59D), X101H (e.g., S101H), X120D (e.g., H120D), X156D (e.g., S156D), X163G (e.g., S163G), X194P (e.g., A194P), X195E (e.g., G195E), X209W (e.g., Y209W), X238E (e.g., N238E), X256D (e.g. N256D), X261D (e.g., N261D), and X262E (e.g., L262E);
(c) X62D (e.g., N62D) and one or more substitutions selected from the group of X101H (e.g., S101H), X104T (e.g., V104T), X156D (e.g., S156D), X163G (e.g., S163G), X170S, X170L (e.g., R170S, R170L), X209W (e.g., Y209W), X238E (e.g., N238E), X245R (e.g. Q245R) and X262E (e.g., L262E);
(d) X62D+X245R+X248D (e.g., N62D+Q245R+N248D) and one or more substitutions selected from the group of X156D (e.g., S156D), X163G (e.g., S163G), X163K (e.g., S163K), X170S (e.g., R170S), X209W (e.g., Y209W), and X262E (e.g., L262E);
(e) X170L, X170N, X170S (e.g. R170L, R170N, R170S) and one or more substitutions selected from the group of X57P (e.g. S57P), X167A (e.g. Y167A), X172E (e.g. A172E), X206E (e.g. Q206E),
(f) X99D (e.g. S99D) and one or more substitutions selected from the group of *97aN, *98aA, X98T (e.g. A98T), X261D (e.g., N261D), and X262Q (e.g., L262Q);
wherein the positions correspond to the positions of the polypeptide of SEQ ID NO: 2.

The present disclosure further relates to the use of the detergent compositions in a cleaning process such as laundry or hard surface cleaning, such as dish wash e.g. automated dish wash. The present disclosure further relates to a method for removing a stain from a surface, which comprises contacting the surface with the detergent composition.

The term “detergent composition”, includes unless otherwise indicated, granular or powder-form all-purpose or heavy-duty washing agents, especially cleaning detergents; liquid, gel or paste-form all-purpose washing agents, especially the so-called heavy-duty liquid (HDL) types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, soap bars, mouthwashes, denture cleaners, car or carpet shampoos, bathroom cleaners; hair shampoos and hair-rinses; shower gels, foam baths; metal cleaners; as well as cleaning auxiliaries such as bleach additives and “stain-stick” or pre-treat types. The terms “detergent composition” and “detergent formulation” are used in reference to mixtures which are intended for use in a wash medium for the cleaning of soiled objects. In some embodiments, the term is used in reference to laundering fabrics and/or garments (e.g., “laundry detergents”). In alternative embodiments, the term refers to other detergents, such as those used to clean dishes, cutlery, etc. (e.g., “dishwashing detergents”). It is not intended that the present disclosure be limited to any particular detergent formulation or composition. The term “detergent composition” is not intended to be limited to compositions that contain surfactants. The term encompasses detergents that may contain, e.g., surfactants, builders, chelators or chelating agents, bleach system or bleach components, polymers, fabric conditioners, foam boosters, suds suppressors, dyes, perfume, tannish inhibitors, optical brighteners, bactericides, fungicides, soil suspending agents, anticorrosion agents, enzyme inhibitors or stabilizers, enzyme activators, transferase(s), hydrolytic enzymes, oxido reductases, bluing agents and fluorescent dyes, antioxidants, and solubilizers.

In addition to containing a subtilase variant as disclosed herein, the detergent formulation of the present disclosure may contain one or more additional enzymes (such as amylases, catalases, cellulases (e.g., endoglucanases), cutinases, haloperoxygenases, lipases, mannanases, pectinases, pectin lyases, peroxidases, proteases, xanthanases, and xyloglucanases, or any mixture thereof), and/or components such as surfactants, builders, chelators or chelating agents, bleach system or bleach components, polymers, fabric conditioners, foam boosters, suds suppressors, dyes, perfume, tannish inhibitors, optical brighteners, bactericides, fungicides, soil suspending agents, anti-corrosion agents, enzyme inhibitors or stabilizers, enzyme activators, transferase(s), hydrolytic enzymes, oxidoreductases, bluing agents and fluorescent dyes, antioxidants, and solubilizers.

The term “dish wash” refers to all forms of washing dishes, e.g., by hand or automatic dish wash. Washing dishes includes, but is not limited to, the cleaning of all forms of crockery such as plates, cups, glasses, bowls, all forms of cutlery such as spoons, knives, forks and serving utensils as well as ceramics, plastics such as melamine, metals, china, glass and acrylics.

The term “dish washing composition” refers to all forms of compositions for cleaning hard surfaces. The present disclosure is not restricted to any particular type of dish wash composition or any particular detergent.

The term “hard surface cleaning” is defined herein as cleaning of hard surfaces wherein hard surfaces may include floors, tables, walls, roofs etc. as well as surfaces of hard objects such as cars (car wash) and dishes (dish wash). Dishwashing includes but are not limited to cleaning of plates, cups, glasses, bowls, and cutlery such as spoons, knives, forks, serving utensils, ceramics, plastics such as melamine, metals, china, glass and acrylics.

The term “improved property” means a characteristic associated with a subtilase variant that is improved compared to the parent subtilase. Such improved properties include, but are not limited to, wash performance, protease activity, thermal activity profile, thermostability, pH activity profile, pH stability, substrate/cofactor specificity, improved surface properties, substrate specificity, product specificity, increased stability, improved stability under storage conditions, and chemical stability.

The term “stability” includes storage stability and stability during use, e.g., during a wash process and reflects the stability of the subtilase variant as a function of time, e.g., how much activity is retained when the subtilase variant is kept in solution in particular in a detergent solution. The stability is influenced by many factors, e.g., pH, temperature, detergent composition, e.g., amount of builder, surfactants etc.

The term “improved stability” or “increased stability” is defined herein as a variant subtilase displaying an increased stability in solution, relative to the stability of the parent subtilase. The terms “improved stability” and “increased stability” includes “improved chemical stability”, “detergent stability” or “improved detergent stability.

The term “improved chemical stability” is defined herein as a variant subtilase displaying retention of enzymatic activity after a period of incubation in the presence of a chemical or chemicals, either naturally occurring or synthetic, which reduces the enzymatic activity of the parent enzyme. Improved chemical stability may also result in variants being more able to catalyze a reaction in the presence of such chemicals. The improved chemical stability is an improved stability of the variant in the detergent composition according to present disclosure, in particular in a liquid detergent. The term “detergent stability” or “improved detergent stability is in particular an improved stability of the protease activity when a subtilase variant is mixed into a liquid detergent formulation, and then stored at a temperature between about 15 and about 50° C., e.g., 20° C., 30° C. or 40° C.

The term “improved thermal activity” means a variant displaying an altered temperature-dependent activity profile at a specific temperature relative to the temperature-dependent activity profile of the parent. The thermal activity value provides a measure of the variant's efficiency in enhancing catalysis of a hydrolysis reaction over a range of temperatures. A more thermo-active variant will lead to an increase in enhancing the rate of hydrolysis of a substrate by an enzyme composition thereby decreasing the time required and/or decreasing the enzyme concentration required for activity. Alternatively, a variant with a reduced thermal activity will enhance an enzymatic reaction at a temperature lower than the temperature optimum of the parent defined by the temperature-dependent activity profile of the parent.

The term “improved wash performance” is defined herein as a detergent composition comprising a subtilase variant as contemplated herein displaying an improved wash performance relative to the wash performance of the detergent composition comprising the corresponding parent protease, e.g., by increased stain removal. The term “wash performance” includes wash performance in laundry but also, e.g., in dish wash. The wash performance may be quantified as described under the definition of “wash performance” herein.

The term “isolated” means a substance in a form or environment which does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., multiple copies of a gene encoding the substance; use of a stronger promoter than the promoter naturally associated with the gene encoding the substance). An isolated substance may be present in a fermentation broth sample.

The term “laundering” relates to both household laundering and industrial laundering and means a process of treating textiles and/or fabrics with a solution containing a detergent composition of the present disclosure. The laundering process can for example be carried out using, e.g., a household or an industrial washing machine or can be carried out by hand.

The term “mature polypeptide” means a polypeptide in its final form following translation and any post-translational modifications, such as N-terminal processing, C-terminal truncation, glycosylation, phosphorylation, autocatalytic activation etc. In one aspect, the mature polypeptide is amino acids 1 to 269 of SEQ ID NO: 1 and 1 to 275 of SEQ ID NO: 2. It is known in the art that a host cell may produce a mixture of two of more different mature polypeptides (i.e., with a different C-terminal and/or N-terminal amino acid) expressed by the same polynucleotide.

The term “mature polypeptide coding sequence” means a polynucleotide that encodes a mature polypeptide having protease activity.

The term “parent” means a protease to which an alteration is made to produce the enzyme variants comprised in the detergent composition of the present disclosure. It will be understood that in the present context the expression “having identical amino acid sequence” relates to 100% sequence identity. In a particular embodiment the parent is a protease with at least about 60% identity, such as at least about 65%, at least about 70%, at least about 75%, at least about 80%, at least about 81%, at least about 82%, at least about 83%, at least about 84%, at least about 85%, at least about 90%, at least about 91%, at least about 92%, at least about 93%, at least about 94%, at least about 95%, at least about 96%, at least about 97%, at least about 98%, at least about 99%, or 100% identity to a polypeptide of SEQ ID NO: 1, 2, 3, 4, 5, 6, 7, 8, 9, 10, or 11.

The term “protease” is defined herein as an enzyme that hydrolyzes peptide bonds. It includes any enzyme belonging to the EC 3.4 enzyme group (including each of the thirteen subclasses thereof). The EC number refers to Enzyme Nomenclature 1992 from NC-IUBMB, Academic Press, San Diego, Calif., including supplements 1-5 published in Eur. J. Biochem. 1223: 1-5 (1994); Eur. J. Biochem. 232: 1-6 (1995); Eur. J. Biochem. 237: 1-5 (1996); Eur. J. Biochem. 250: 1-6 (1997); and Eur. J. Biochem. 264: 610-650 (1999); respectively. The most widely used proteases in the detergent industry such as laundry and dish wash are the serine proteases or serine peptidases which is a subgroup of proteases exemplified by having a serine in the active site, which forms a covalent adduct with the substrate. Further the subtilases (and the serine proteases) are exemplified by having two active site amino acid residues apart from the serine, namely a histidine residue and an aspartic acid residue. Subtilase refer to a sub-group of serine protease according to Siezen et al., 1991, Protein Engng. 4: 719-737 and Siezen et al., 1997, Protein Science 6: 501-523. The subtilases may be divided into 6 sub-divisions, i.e., the Subtilisin family, the Thermitase family, the Proteinase K family, the Lantibiotic peptidase family, the Kexin family and the Pyrolysin family. The term “protease activity” means a proteolytic activity (EC 3.4). Proteases usably in detergents are mainly endopeptidases (EC 3.4.21). There are several protease activity types: The three main activity types are: trypsin-like where there is cleavage of amide substrates following Arg or Lys at P1, chymotrypsin-like where cleavage occurs following one of the hydrophobic amino acids at P1, and elastase-like with cleavage following an Ala at P1. For purposes of the present disclosure, protease activity is determined according to the Suc-AAPF-pNA activity assay, as described in the Materials and Methods section below. In one aspect, the subtilase variants of the present disclosure have at least about 20%, e.g., at least about 40%, at least about 50%, at least about 60%, at least about 70%, at least about 80%, at least about 90%, at least about 95%, or at least 100% of the enzyme activity of the mature polypeptide of the parent enzyme. In one particular aspect the subtilase variants of the present disclosure have at least about 20%, e.g., at least about 40%, at least about 50%, at least about 60%, at least about 70%, at least about 80%, at least about 90%, at least about 95%, or at least 100% of the enzyme activity of a polypeptide of SEQ ID NO: 1, 2, 3, 4, 5, 6, 7, 8, 9, 10, or 11.

The term “protease activity” means a proteolytic activity (EC 3.4). Proteases of the present disclosure are endopeptidases (EC 3.4.21). There are several protease activity types: The three main activity types are: trypsin-like where there is cleavage of amide substrates following Arg or Lys at P1, chymotrypsin-like where cleavage occurs following one of the hydrophobic amino acids at P1, and elastase-like with cleavage following an Ala at P1. For purposes of the present disclosure, protease activity is determined according to the procedure described in “Materials and Methods” below. The subtilase variants of the present disclosure preferably have at least about 20%, e.g., at least about 40%, at least about 50%, at least about 60%, at least about 70%, at least about 80%, at least about 90%, at least about 95%, and at least 100% of the protease activity of a polypeptide of SEQ ID NO: 1, 2, 3, 4, 5, 6, 7, 8, 9, 10, or 11.

The relatedness between two amino acid sequences or between two nucleotide sequences is described by the parameter “sequence identity”. For purposes of the present disclosure, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows: (Identical Residues×100)/(Length of Alignment−Total Number of Gaps in Alignment)

The term “substantially pure variant” means a preparation that contains at most 10%, at most about 8%, at most about 6%, at most about 5%, at most about 4%, at most about 3%, at most about 2%, at most about 1%, and at most about 0.5% by weight of other polypeptide material with which it is natively or recombinantly associated. Preferably, the variant is at least about 92% pure, e.g., at least about 94% pure, at least about 95% pure, at least about 96% pure, at least about 97% pure, at least about 98% pure, at least about 99%, at least about 99.5% pure, and 100% pure by weight of the total polypeptide material present in the preparation. The variants comprised in the detergent composition of the present disclosure are preferably in a substantially pure form. This can be accomplished, for example, by preparing the variant by well-known recombinant methods or by classical purification methods.

The term “textile” refers to woven fabrics, as well as staple fibers and filaments suitable for conversion to or use as yarns, woven, knit, and non-woven fabrics. The term encompasses yarns made from natural, as well as synthetic (e.g., manufactured) fibers. The term, “textile materials” is a general term for fibers, yarn intermediates, yarn, fabrics, and products made from fabrics (e.g., garments and other articles).

The term “non-fabric detergent compositions” include non-textile surface detergent compositions, including but not limited to compositions for hard surface cleaning, such as dishwashing detergent compositions, oral detergent compositions, denture detergent compositions, and personal cleansing compositions.

The term “effective amount of enzyme” refers to the quantity of enzyme necessary to achieve the enzymatic activity required in the specific application, e.g., in a defined detergent composition. Such effective amounts are readily ascertained by one of ordinary skill in the art and are based on many factors, such as the particular enzyme used, the cleaning application, the specific composition of the detergent composition, and whether a liquid or dry (e.g., granular, bar) composition is required, and the like. The term “effective amount” of a protease variant refers to the quantity of protease variant described hereinbefore that achieves a desired level of enzymatic activity, e.g., in a defined detergent composition.

The term “water hardness” or “degree of hardness” or “dH” or “° dH” as used herein refers to German degrees of hardness. One degree is defined as 10 milligrams of calcium oxide per litre of water.

The term “relevant washing conditions” is used herein to indicate the conditions, particularly washing temperature, time, washing mechanics, detergent concentration, type of detergent and water hardness, actually used in households in a detergent market segment.

The term “adjunct materials” means any liquid, solid or gaseous material selected for the particular type of detergent composition desired and the form of the product (e.g., liquid, granule, powder, bar, paste, spray, tablet, gel, or foam composition), which materials are also preferably compatible with the protease variant enzyme used in the composition. In some embodiments, granular compositions are in “compact” form, while in other embodiments, the liquid compositions are in a “concentrated” form.

The term “stain removing enzyme” as used herein, describes an enzyme that aids the removal of a stain or soil from a fabric or a hard surface. Stain removing enzymes act on specific substrates, e.g., protease on protein, amylase on starch, lipase and cutinase on lipids (fats and oils), pectinase on pectin and hemicellulases on hemicellulose. Stains are often depositions of complex mixtures of different components which either results in a local discolouration of the material by itself or which leaves a sticky surface on the object which may attract soils dissolved in the washing liquor thereby resulting in discolouration of the stained area. When an enzyme acts on its specific substrate present in a stain the enzyme degrades or partially degrades its substrate thereby aiding the removal of soils and stain components associated with the substrate during the washing process. For example, when a protease acts on a grass stain it degrades the protein components in the grass and allows the green/brown colour to be released during washing.

The term “reduced amount” means in this context that the amount of the component is smaller than the amount which would be used in a reference process under otherwise the same conditions. In a preferred embodiment the amount is reduced by, e.g., at least about 5%, such as at least about 10%, at least about 15%, at least about 20% or as otherwise herein described.

The term “low detergent concentration” system includes detergents where less than about 800 ppm of detergent components is present in the wash water. Asian, e.g., Japanese detergents are typically considered low detergent concentration systems.

The term “medium detergent concentration” system includes detergents wherein between about 800 ppm and about 2000 ppm of detergent components is present in the wash water. North American detergents are generally considered to be medium detergent concentration systems.

The term “high detergent concentration” system includes detergents wherein greater than about 2000 ppm of detergent components is present in the wash water. European detergents are generally considered to be high detergent concentration systems.

The term “variant” means a polypeptide having protease activity comprising an alteration, i.e., a substitution, insertion, and/or deletion, at three or more (e.g., several) positions. A substitution means replacement of the amino acid occupying a position with a different amino acid; a deletion means removal of the amino acid occupying a position; and an insertion means adding one or more (e.g., several) amino acids, e.g., 1, 2, 3, 4 or 5 amino acids adjacent to and immediately following the amino acid occupying a position. The term subtilase variant means a variant of a subtilase parent, i.e., a subtilase variant is a subtilase which comprises alterations i.e., a substitution, insertion, and/or deletion, at three or more (e.g., several) positions compared to the parent subtilase.

The term “wash performance” is used as an enzyme's ability to remove stains present on the object to be cleaned during, e.g., wash, such as laundry or hard surface cleaning.

The improvement in the wash performance may be quantified by calculating the so-called intensity value (Int) defined in the AMSA assay, as described in Example 3.

The term “wild-type subtilase” means a protease expressed by a naturally occurring organism, such as a bacterium, archaea, yeast, fungus, plant or animal found in nature. An example of a wild-type subtilase is subtilisin BPN′, i.e., amino acids 1 to 275 of SEQ ID NO: 2.

### Conventions for Designation of Variants

For purposes of the present disclosure, subtilisin BPN′ (the sequence of amino acids 1-275 of SEQ ID NO: 2) is used to determine the corresponding amino acid residue in another protease. The amino acid sequence of another protease is aligned with the mature polypeptide disclosed in SEQ ID NO: 2, and based on the alignment, the amino acid position number corresponding to any amino acid residue in the polypeptide disclosed in SEQ ID NO: 2 is determined using the Needleman-Wunsch algorithm as implemented in the Needle program of the EMBOSS package (EMBOSS: The European Molecular Biology Open Software Suite), preferably version 5.0.0 or later. The parameters used are gap open penalty of 10, gap extension penalty of 0.5, and the EBLOSUM62 (EMBOSS version of BLOSUM62) substitution matrix.

Identification of the corresponding amino acid residue in another protease can be determined by an alignment of multiple polypeptide sequences using several computer programs including, but not limited to, MUSCLE (multiple sequence comparison by log-expectation; version 3.5 or later), MAFFT (version 6.857 or later), and EMBOSS EMMA employing ClustalW (1.83 or later), using their respective default parameters.

When the other enzyme has diverged from the mature polypeptide of SEQ ID NO: 2 such that traditional sequence-based comparison fails to detect their relationship, other pairwise sequence comparison algorithms can be used. Greater sensitivity in sequence-based searching can be attained using search programs that utilize probabilistic representations of polypeptide families (profiles) to search databases. For example, the PSI-BLAST program generates profiles through an iterative database search process and is capable of detecting remote homologs. Even greater sensitivity can be achieved if the family or superfamily for the polypeptide has one or more representatives in the protein structure databases. Programs such as GenTHREADER utilize information from a variety of sources (PSI-BLAST, secondary structure prediction, structural alignment profiles, and solvation potentials) as input to a neural network that predicts the structural fold for a query sequence. Similarly, the method of Gough et al., 2000, J. Mol. Biol. 313: 903-919, can be used to align a sequence of unknown structure with the superfamily models present in the SCOP database. These alignments can in turn be used to generate homology models for the polypeptide, and such models can be assessed for accuracy using a variety of tools developed for that purpose.

For proteins of known structure, several tools and resources are available for retrieving and generating structural alignments. For example the SCOP superfamilies of proteins have been structurally aligned, and those alignments are accessible and downloadable. Two or more protein structures can be aligned using a variety of algorithms such as the distance alignment matrix or combinatorial extension, and implementation of these algorithms can additionally be utilized to query structure databases with a structure of interest in order to discover possible structural homologs.

In describing the variants of the present disclosure, the nomenclature described below is adapted for ease of reference. The accepted IUPAC single letter or three letter amino acid abbreviation is employed.

In an embodiment, the subtilase variants comprised in the detergent composition of present disclosure comprise X167A+R170S+A194P (e.g., Y167A+R170S+A194P) and one or more substitutions selected from the group of X59D (e.g., Q59D), X62D (e.g., N62D), (X76D (e.g., N76D), X104T (e.g., V104T), X120D (e.g., H120D), X133P (e.g. A133P), X141N (e.g. S141N), X156D (e.g., S156D), X163G (e.g., S163G), X209W (e.g., Y209W), X228V (e.g. A228V), X230V (e.g. A230V), X238E (e.g., N238E), X261D (e.g., N261D), and X262E (e.g., L262E); and optionally may further comprise one or alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), *99aD, X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X245K (e.g., Q245K), X245R (e.g., Q245R), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment, the subtilase variants comprised in the detergent composition of present disclosure comprise *99aE and one or more substitutions selected from the group of X21D (e.g., L21D), X59D (e.g., Q59D), X101H (e.g., S101H), X120D (e.g., H120D), X156D (e.g., S156D), X163G (e.g., S163G), X194P (e.g., A194P), X195E (e.g., G195E), X209W (e.g., Y209W), X238E (e.g., N238E), X256D (e.g. N256D), X261D (e.g., N261D), and X262E (e.g., L262E); and optionally may further comprise one or more alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X167A (e.g., Y167A), X170S (e.g., R170S), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X194P (e.g., A194P), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., 52161), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X245K (e.g., Q245K), X245R (e.g., Q245R), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment, the subtilase variants comprised in the detergent composition of present disclosure comprised in the detergent composition of present disclosure comprise X62D (e.g., N62D) and one or more substitutions selected from the group of X101H (e.g., S101H), X104T (e.g., V104T), X156D (e.g., S156D), X163G (e.g., S163G), X170S (e.g., R170S), X170L (e.g., R170L), X209W (e.g., Y209W), X238E (e.g., N238E), and X262E (e.g., L262E); and optionally may further comprise one or more alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), *99aD, X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X167A (e.g., Y167A), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X194P (e.g., A194P), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X245K (e.g., Q245K), X245R (e.g., Q245R), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment, the subtilase variants comprised in the detergent composition of present disclosure comprise X62D+X245R+X248D (e.g., N62D+Q245R+N248D) and one or more substitutions selected from the group of X156D (e.g., S156D), X163G (e.g., S163G), X163K (e.g., S163K), X170S (e.g., R170S), X209W (e.g., Y209W), and X262E (e.g., L262E); and optionally may further comprise one or more alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), *99aD, X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X167A (e.g., Y167A), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X194P (e.g., A194P), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment, the subtilase variants comprised in the detergent composition of present disclosure comprise X170L, X170N, X170S (e.g. R170L, R170N, R170S) and one or more substitutions selected from the group of X57P (e.g. S57P), X167A (e.g. Y167A), X172E (e.g. A172E), X206E (e.g. Q206E); and optionally may further comprise one or more alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), *99D, X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X167A (e.g., Y167A), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X194P (e.g., A194P), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment, the subtilase variants comprised in the detergent composition of present disclosure comprise X99D (e.g. S99D) and one or more substitutions selected from the group of *97aN, *98aA, X98T (e.g. A98T), X261D (e.g., N261D), and X262Q (e.g., L262Q); and optionally may further comprise one or more alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), *99D, X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X167A (e.g., Y167A), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X194P (e.g., A194P), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment the subtilase variant comprised in the detergent composition of present disclosure comprises X167A+R170S+A194P (e.g., Y167A+R170S+A194P) and one or more substitutions selected from the group of X59D (e.g., Q59D), X62D (e.g., N62D), X76D (e.g., N76D), X104T (e.g., V104T), X120D (e.g., H120D), X133P (e.g. A133P), X141N (e.g. S141N), X156D (e.g., S156D), X163G (e.g., S163G), X209W (e.g., Y209W), X228V (e.g. A228V), X230V (e.g. A230V), X238E (e.g., N238E), X261D (e.g., N261D), and X262E (e.g., L262E), wherein

(i) the positions correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X59D (e.g., Q59D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X62D (e.g., N62D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X76D (e.g., N76D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X104T (e.g., V104T), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X120D (e.g., H120D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X133P (e.g. A133P, wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X141N (e.g. S141N), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X156D (e.g., S156D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X163G (e.g., S163G), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X209W (e.g., Y209W), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X228V (e.g. A228V), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X230V (e.g. A230V), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X238E (e.g., N238E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X261D (e.g., N261D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises X167A+R170S+A194P (e.g., Y167A+R170S+A194P) and the substitution X262E (e.g., L262E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and one or more substitutions selected from the group of X21D (e.g., L21D), X59D (e.g., Q59D), X101H (e.g., S101H), X120D (e.g., H120D), X156D (e.g., S156D), X163G (e.g., S163G), X194P (e.g., A194P), X195E (e.g., G195E), X209W (e.g., Y209W), X238E (e.g., N238E), X256D (e.g. N256D), X261D (e.g., N261D), and X262E (e.g., L262E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X21D (e.g., L21D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X59D (e.g., Q59D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X101H (e.g., S101H), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X120D (e.g., H120D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X156D (e.g., S156D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X163G (e.g., S163G), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X194P (e.g., A194P), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X195E (e.g., G195E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X209W (e.g., Y209W), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X238E (e.g., N238E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X256D (e.g. N256D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X261D (e.g., N261D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the insertion *99aE and the substitution X262E (e.g., L262E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and one or more substitutions selected from the group of X101H (e.g., S101H), X104T (e.g., V104T), X156D (e.g., S156D), X163G (e.g., S163G), X170S, X170L (e.g., R170S, R170L), X209W (e.g., Y209W), X238E (e.g., N238E), X245R (e.g. Q245R) and X262E (e.g., L262E), wherein

(i) the positions correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X101H (e.g., S101H), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X104T (e.g., V104T), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X156D (e.g., S156D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X163G (e.g., S163G), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X170S, or X170L (e.g., R170S or R170L), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X209W (e.g., Y209W), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X238E (e.g., N238E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X245R (e.g. Q245R) wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X62D (e.g., N62D) and the substitution X262E (e.g., L262E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X62D+X245R+X248D (e.g., N62D+Q245R+N248D) and one or more substitutions selected from the group of X156D (e.g., S156D), X163G (e.g., S163G), X163K (e.g., S163K), X170S (e.g., R170S), X209W (e.g., Y209W), and X262E (e.g., L262E), wherein

(i) the positions correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X62D+X245R+X248D (e.g., N62D+Q245R+N248D) and the substitution X156D (e.g., S156D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X62D+X245R+X248D (e.g., N62D+Q245R+N248D) and the substitution X163G (e.g., S163G), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X62D+X245R+X248D (e.g., N62D+Q245R+N248D) and the substitution X163K (e.g., S163K), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X62D+X245R+X248D (e.g., N62D+Q245R+N248D) and the substitution X170S (e.g., R170S), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X62D+X245R+X248D (e.g., N62D+Q245R+N248D) and the substitution X209W (e.g., Y209W), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X62D+X245R+X248D (e.g., N62D+Q245R+N248D) and the substitution X262E (e.g., L262E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X170L, X170N or X170S (e.g. R170L, R170N, R170S) and one or more substitutions selected from the group of X57P (e.g. S57P), X167A (e.g. Y167A), X172E (e.g. A172E), X206E (e.g. Q206E), wherein

(i) the positions correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X170L, X170N or X170S (e.g. R170L, R170N, R170S) and the substitution X57P (e.g. S57P), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X170L, X170N or X170S (e.g. R170L, R170N, R170S) and the substitution X167A (e.g. Y167A), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X170L, X170N or X170S (e.g. R170L, R170N, R170S) and the substitution, X172E (e.g. A172E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitutions X170L, X170N or X170S (e.g. R170L, R170N, R170S) and the substitution X206E (e.g. Q206E), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X99D (e.g. S99D) and one or more alterations selected from the group of *97aN, *98aA, X98T (e.g. A98T), X261D (e.g., N261D), and X262Q (e.g., L262Q), wherein

(i) the positions correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X99D (e.g. S99D) and the insertion *97aN, wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X99D (e.g. S99D) and the insertion *98aA, wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X99D (e.g. S99D) and the substitution X98T (e.g. A98T), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X99D (e.g. S99D) and the substitution X261D (e.g., N261D), wherein

(i) the position correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay.

In another embodiment the subtilase variant comprised in the detergent composition of present disclosure comprises the substitution X99D (e.g. S99D) and the substitution X262Q (e.g., L262Q), wherein

(i) the position correspond to the positions of the polypeptide of SEQ ID NO: 2;
(ii) the variant has protease activity and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11 and wherein optionally the variant has an improved wash performance compared to SEQ ID NO: 1 when measured in AMSA assay. and wherein optionally the variant has an improved wash performance compared to SEQ ID NO: 1 when measured in AMSA assay.

The present disclosure relates to detergent compositions comprising subtilase variants having protease activity and comprising

(a) X167A+R170S+A194P (e.g., Y167A+R170S+A194P) and one or more substitutions selected from the group of X59D (e.g., Q59D), X62D (e.g., N62D), X76D (e.g., N76D), X104T (e.g., V104T), X120D (e.g., H120D), X133P (e.g. A133P), X141N (e.g. S141N), X156D (e.g., S156D), X163G (e.g., S163G), X209W (e.g., Y209W), X228V (e.g. A228V), X230V (e.g. A230V), X238E (e.g., N238E), X261D (e.g., N261D), and X262E (e.g., L262E);
(b) *99aE and one or more substitutions selected from the group of X21D (e.g L21D), X59D (e.g., Q59D), X101H (e.g., S101H), X120D (e.g., H120D), X156D (e.g., S156D), X163G (e.g., S163G), X194P (e.g., A194P), X195E (e.g., G195E), X209W (e.g., Y209W), X238E (e.g., N238E), X256D (e.g. N256D), X261D (e.g., N261D), and X262E (e.g., L262E);
(c) X62D (e.g., N62D) and one or more substitutions selected from the group of X101H (e.g., S101H), X104T (e.g., V104T), X156D (e.g., S156D), X163G (e.g., S163G), X170S, X170L (e.g., R170S, R170L), X209W (e.g., Y209W), X238E (e.g., N238E), X245R (e.g. Q245R) and X262E (e.g., L262E);
(d) X62D+X245R+X248D (e.g., N62D+Q245R+N248D) and one or more substitutions selected from the group of X156D (e.g., S156D), X163G (e.g., S163G), X163K (e.g., S163K), X170S (e.g., R170S), X209W (e.g., Y209W), and X262E (e.g., L262E);
(e) X170L, X170N, X170S (e.g. R170L, R170N, R170S) and one or more substitutions selected from the group of X57P (e.g. S57P), X167A (e.g. Y167A), X172E (e.g. A172E), X206E (e.g. Q206E),
(f) X99D (e.g. S99D) and one or more substitutions selected from the group of *97aN, *98aA, X98T (e.g. A98T), X261D (e.g., N261D), and X262Q (e.g., L262Q), wherein the positions correspond to the positions of the polypeptide of SEQ ID NO: 2.

Whenever the terms “variant(s)” or “subtilase variant(s)” are mentioned further on, they refer to the protease variant(s) comprised in the detergent composition according to present disclosure.

In one embodiment, the subtilase variant comprised in the detergent composition according to present disclosure has improved stability, in particular improved storage stability, compared to the parent subtilase. In a preferred embodiment, the subtilase variant has improved stability, in particular improved storage stability, and on par or improved wash performance compared to the parent subtilase.

In another embodiment, the subtilase variant comprised in the detergent composition of present disclosure is

a) a polypeptide that has at least 60% but less than 100% sequence identity to the amino acid sequence of the parent subtilase;

In an embodiment, the subtilase variant has at least about 65% but less than 100% sequence identity to the parent subtilase. In an embodiment, the subtilase variant has at least about 70% but less than 100% sequence identity to the parent subtilase. In an embodiment, the subtilase variant has at least about 75% but less than 100% sequence identity to the parent subtilase. In an embodiment, the subtilase variant has at least about 80% but less than 100% sequence identity to the parent subtilase. In an embodiment, the subtilase variant has at least about 85% but less than 100% sequence identity to the parent subtilase. In an embodiment, the subtilase variant has at least about 90% but less than 100% sequence identity to the parent subtilase. In an embodiment, the subtilase variant has at least about 93% but less than 100% sequence identity to the parent subtilase. In an embodiment, the subtilase variant has at least about 95% but less than 100% sequence identity to the parent subtilase. In an embodiment, the subtilase variant has at least about 96% but less than 100% sequence identity to the parent subtilase. In an embodiment, the subtilase variant has at least about 97% but less than 100% sequence identity to the parent subtilase. In an embodiment, the subtilase variant has at least about 98% but less than 100% sequence identity to the parent subtilase.

In an embodiment, the variant has an amino acid sequence which is at least about 60% identical to SEQ ID NO: 1, e.g., at least about 60%, such as at least about 70%, such as at least about 80%, such as at least about 90%, such as at least about 95% sequence identity to the amino acid sequence of SEQ ID NO: 1.

In another embodiment, the variant has an amino acid sequence which is at least about 60% identical to SEQ ID NO: 2, e.g., at least about 60%, such as at least about 70%, such as at least about 80%, such as at least about 90%, such as at least about 95% sequence identity to the amino acid sequence of SEQ ID NO: 2.

In another embodiment, the variant has an amino acid sequence which is at least about 60% identical to SEQ ID NO: 3, e.g., at least about 60%, such as at least about 70%, such as at least about 80%, such as at least about 90%, such as at least about 95% sequence identity to the amino acid sequence of SEQ ID NO: 3.

In another embodiment, the variant has an amino acid sequence which is at least about 60% identical to SEQ ID NO: 4, e.g., at least about 60%, such as at least about 70%, such as at least about 80%, such as at least about 90%, such as at least about 95% sequence identity to the amino acid sequence of SEQ ID NO: 4.

In another embodiment, the variant has an amino acid sequence which is at least about 60% identical to SEQ ID NO: 5, e.g., at least about 60%, such as at least about 70%, such as at least about 80%, such as at least about 90%, such as at least about 95% sequence identity to the amino acid sequence of SEQ ID NO: 5.

In another embodiment, the variant has an amino acid sequence which is at least about 60% identical to SEQ ID NO: 6, e.g., at least about 60%, such as at least about 70%, such as at least about 80%, such as at least about 90%, such as at least about 95% sequence identity to the amino acid sequence of SEQ ID NO: 6.

In another embodiment, the variant has an amino acid sequence which is at least about 60% identical to SEQ ID NO: 7, e.g., at least about 60%, such as at least about 70%, such as at least about 80%, such as at least about 90%, such as at least about 95% sequence identity to the amino acid sequence of SEQ ID NO: 7.

In another embodiment, the variant has an amino acid sequence which is at least about 60% identical to SEQ ID NO: 8, e.g., at least about 60%, such as at least about 70%, such as at least about 80%, such as at least about 90%, such as at least about 95% sequence identity to the amino acid sequence of SEQ ID NO: 8.

In another embodiment, the variant has an amino acid sequence which is at least about 60% identical to SEQ ID NO: 9, e.g., at least about 60%, such as at least about 70%, such as at least about 80%, such as at least about 90%, such as at least about 95% sequence identity to the amino acid sequence of SEQ ID NO: 9.

In another embodiment, the variant has an amino acid sequence which is at least about 60% identical to SEQ ID NO: 10, e.g., at least about 60%, such as at least about 70%, such as at least about 80%, such as at least about 90%, such as at least about 95% sequence identity to the amino acid sequence of SEQ ID NO: 10.

In another embodiment, the variant has an amino acid sequence which is at least about 60% identical to SEQ ID NO: 11, e.g., at least about 60%, such as at least about 70%, such as at least about 80%, such as at least about 90%, such as at least about 95% sequence identity to the amino acid sequence of SEQ ID NO: 11.

In one aspect, the total number of alterations in the parent subtilase is between 3 and 30, preferably between 3 and 20, more preferably between 3 and 15, even more preferably between 3 and 10, most preferably between 3 and 8 alterations. In another aspect, total number of alterations in the parent subtilase is 3, 4, 5, 6, 7, 8, 9, 10, 11, 12, 13, 14, 15, 16, 17, 18, 19, 20, 21, 22, 23, 24, 25, 26, 27, 28, 29 or 30 alterations.

The subtilase variants comprised in the detergent composition of the present disclosure may further comprise one or more additional alterations. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for protease activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. For BPN′ (SEQ ID NO: 2) the catalytic triad comprising the amino acids 5221, H64, and D32 is essential for protease activity of the enzyme.

In an embodiment, the subtilase variants comprised in the detergent composition of present disclosure comprise X167A+R170S+A194P (e.g., Y167A+R170S+A194P) and one or more substitutions selected from the group of X59D (e.g., Q59D), X76D (e.g., N76D), X104T (e.g., V104T), X120D (e.g., H120D), X156D (e.g., S156D), X163G (e.g., S163G), X209W (e.g., Y209W), X238E (e.g., N238E), X261D (e.g., N261D), and X262E (e.g., L262E); and optionally may further comprise one or alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., 524R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), *99D, X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X245K (e.g., Q245K), X245R (e.g., Q245R), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment, the subtilase variants comprised in the detergent composition of present disclosure comprise *99aE and one or more substitutions selected from the group of X59D (e.g., Q59D), X101H (e.g., S101H), X120D (e.g., H120D), X156D (e.g., S156D), X163G (e.g., S163G), X194P (e.g., A194P), X195E (e.g., G195E), X209W (e.g., Y209W), X238E (e.g., N238E), X261D (e.g., N261D), and X262E (e.g., L262E); and optionally may further comprise one or more alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X167A (e.g., Y167A), X170S (e.g., R170S), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X194P (e.g., A194P), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X245K (e.g., Q245K), X245R (e.g., Q245R), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment, the subtilase variants comprised in the detergent composition of present disclosure comprise X62D (e.g., N62D) and one or more substitutions selected from the group of X101H (e.g., S101H), X104T (e.g., V104T), X156D (e.g., S156D), X163G (e.g., S163G), X170S (e.g., R170S), X209W (e.g., Y209W), X238E (e.g., N238E), and X262E (e.g., L262E); and optionally may further comprise one or more alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), *99D, X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X167A (e.g., Y167A), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X194P (e.g., A194P), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X245K (e.g., Q245K), X245R (e.g., Q245R), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In another embodiment, the subtilase variants comprised in the detergent composition of present disclosure comprise X62D+X245R+X248D (e.g., N62D+Q245R+N248D) and one or more substitutions selected from the group of X156D (e.g., S156D), X163G (e.g., S163G), X163K (e.g., S163K), X170S (e.g., R170S), X209W (e.g., Y209W), and X262E (e.g., L262E); and optionally may further comprise one or more alterations selected from the group of X3T (e.g., S3T), X4I (e.g., V4I), X9C (e.g., S9C), X9D (e.g., S9D), X9E (e.g., S9E), X9Q (e.g., S9Q), X14T (e.g., A15T), X24G (e.g., S24G), X24R (e.g., S24R), X27R (e.g., K27R), *36D, X43A (e.g., N43A), X43C (e.g., N43C), X43L (e.g., N43L), X43R (e.g., N43R), X43W (e.g., N43W), X68A (e.g., V68A), X72A (e.g., I72A), X72V (e.g., I72V), X76D (e.g., N76D), X78D (e.g., S78D), X87R (e.g., N87R), X87S (e.g., N87S), *97E, X98S (e.g., A98S), X99A (e.g., S99A), X99D (e.g., S99D), X99A (e.g., S99A), X99D (e.g., S99D), X99E (e.g., S99E), X99G (e.g., S99G), *99D, X101D (e.g., S101D), X101E (e.g., S101E), X101G (e.g., S101G), X101I (e.g., S101I), X101K (e.g., S101K), X101L (e.g., S101L), X101M (e.g., S101M), X101N (e.g., S101N), X101R (e.g., S101R), X103A (e.g., S103A), X104F (e.g., V104F), X104I (e.g., V104I), X104N (e.g., V104N), X104Y (e.g., V104Y), X106A (e.g., S106A), X114V (e.g., A114V), X115T (e.g., G115T), X115W (e.g., G115W), X118R (e.g., G118R), X118V (e.g., G118V), X120D (e.g., H120D), X120I (e.g., H120I), X120N (e.g., H120N), X120T (e.g., H120T), X120V (e.g., H120V), X123S (e.g., N123S), X128A (e.g., S128A), X128L (e.g., S128L), X128S (e.g., S128S), X129D (e.g., P129D), X129N (e.g., P129N), X129Q (e.g., P129Q), X130A (e.g., S130A), X147W (e.g., V147W), X149C (e.g., V149C), X149N (e.g., V149N), X158E (e.g., A158E), X160D (e.g., G160D, X160P (e.g., G160P), X161C (e.g., S161C), X161E (e.g., S161E), X162L (e.g., I162L), X163A (e.g., S163A), X163D (e.g., S163D), X167A (e.g., Y167A), X182C (e.g., Q182C), X182E (e.g., Q182E), X185C (e.g., N185C), X185E (e.g., N185E), X188C (e.g., S188C), X188D (e.g., S188D), X188E (e.g., S188E), X191N (e.g., Q191N), X194P (e.g., A194P), X195E (e.g., G195E), X199M (e.g., V199M), X204D (e.g., N204D), X204V (e.g., N204V), X205I (e.g., V205I), X206C (e.g., Q206C), X206E (e.g., Q206E), X206I (e.g., Q206I), X206K (e.g., Q206K), X206L (e.g., Q206L), X206T (e.g., Q206T), X206V (e.g., Q206V), X206W (e.g., Q206W), X209W (e.g., Y209W), X212A (e.g., S212A), X212D (e.g., S212D), X212G (e.g., S212G), X212N (e.g., S212N), X216I (e.g., S216I), X216T (e.g., S216T), X216V (e.g., S216V), X217C (e.g., L217C), X217D (e.g., L217D), X217E (e.g., L217E), X217M (e.g., L217M), X217Q (e.g., L217Q), X217Y (e.g., L217Y), X218D (e.g., N218D), X218E (e.g., N218E), X218T (e.g., N218T), X222C (e.g., M222C), X222R (e.g., M222R), X222S (e.g., M222S), X225A (e.g., P225A), X232V (e.g., A232V), X235L (e.g., K235L), X236H (e.g., Q236H), X252K (e.g., N252K), X255C (e.g., T255C), X255E (e.g., T255E), X256A (e.g., S256A), X256C (e.g., S256C), X256D (e.g., S256D), X256V (e.g., S256V), X256Y (e.g., S256Y), X259D (e.g., S259D), X260E (e.g., T260E), X260P (e.g., T260P), X261C (e.g., N261C), X261E (e.g., N261E), X261F (e.g., N261F), X261L (e.g., N261L), X261M (e.g., N261M), X261V (e.g., N261V), X261W (e.g., N261W), X261Y (e.g., N261Y), X262C (e.g., L262C), X262E (e.g., L262E), X262Q (e.g., L262Q), and X274A (e.g., T274A), wherein each position corresponds to the position of the polypeptide of SEQ ID NO: 2.

In an embodiment, the subtilase variant comprised in the detergent composition of present disclosure is selected from the group of:

*99aE+A194P

### N76D+Y167A+R170S+A194P

### N76D+Y167A+R170S+A194P+A228V+A230V

*99aE+S256D

### L21D+*99aE

### N62D+Q245R+R170S

### R170L+Q206E+S57P

### A133P+Y167A+R170S+A194P

### S141N+Y167A+R170S+A194P

### Y167A+R170N

### Y167A+R170S+A172E

### N62D+Y167A+R170S+A194P

### N62D+R170S

### N62D+R170L

*97aN+A98T+S99D
*98aA+S99D+N261D+L262Q

### Q59D+N76D+Y167A+R170S+A194P

### Q59D+*99aE+Y209W+L262E

### Q59D+Y167A+R170S+A194P+Y209W+L262E

### Q59D+Y167A+R170S+A194P+L262E

### N62D+S101H+R170S+Y209W+L262E

### N62D+V104T+S156D+R170S+Y209W+L262E

### N62D+V104T+R170S+Y209W+L262E

### N62D+S156D+S163G+Y209W+Q245R+N248D+L262E

### N62D+S156D+S163G+Y209W+L262E

### N62D+S156D+S163K+Y209W+Q245R+N248D+L262E

### N62D+S156D+R170S+Y209W+L262E

### N62D+R170S+Y209W+Q245R+N248D+L262E

### N62D+R170S+Y209W+L262E

### N62D+R170S+N238E+L262E

### N76D+Y167A+R170S+A194P+N238E

*99aE+S101H+H120D+S163G+N261D
*99aE+S156D+Y209W+L262E
*99aE+B194P+G195E+Y209W+L262E
*99aE+B194P+G195E+L262E
*99aE+N238E+L262E

### V104T+H120D+S163G+Y167A+R170S+A194P+N261D

### V104T+S156D+Y167A+R170S+A194P+Y209W+L262E

### V104T+Y167A+R170S+A194P+Y209W+N238E+L262E

### V104T+Y167A+R170S+A194P+N238E+L262E.

The subtilase variants may consist of from about 150 to about 350, e.g., from about 175 to about 330, from about 200 to about 310, from about 220 to about 300, from about 240 to about 290, from about 260 to about 280 or 269, 270, 271, 272, 273, 274 or 275 amino acids.

In one embodiment, the detergent composition of present disclosure comprises a subtilase variant having improved stability, in particular improved storage stability, compared to the parent subtilase. In a preferred embodiment, the subtilase variant has improved stability, in particular improved storage stability, and on par or improved wash performance compared to the parent subtilase.

In one embodiment, the detergent composition of present disclosure comprises a subtilase variant having improved stability, in particular improved wash stability, compared to the parent subtilase. In a preferred embodiment, the subtilase variant has improved stability, in particular improved in storage stability, and on par or improved wash performance compared to the parent subtilase.

In an embodiment, the detergent composition of present disclosure comprises a subtilase variant having improved stability, in particular improved in wash stability, and on par or improved wash performance compared to the parent subtilase wherein wash stability is measured using the ‘in wash stability assay’ and wash performance is measured using the Automatic Mechanical Stress Assay (AMSA) as described in Example 2.

### Parent Protease

The parent or the precursor protease may be any subtilase or even more preferred any subtilisin as defined below.

Enzymes cleaving the amide linkages in protein substrates are classified as proteases, or (interchangeably) peptidases.

### Serine Proteases

A serine protease is an enzyme, which catalyzes the hydrolysis of peptide bonds, and in which there is an essential serine residue at the active site.

The bacterial serine proteases have molecular weights in the from about 20,000 to about 45,000 Dalton range. They are inhibited by diisopropylfluorophosphate. They hydrolyze simple terminal esters and are similar in activity to eukaryotic chymotrypsin, also a serine protease. A more narrow term, alkaline protease, covering a sub-group, reflects the high pH optimum of some of the serine proteases, from pH from about 9.0 to about 11.0.

### Subtilases

A sub-group of the serine proteases tentatively designated subtilases has been proposed by Siezen et al., 1991, Protein Eng. 4:719-737 and Siezen et al., 1997, Protein Science 6:501-523. They are defined by homology analysis of more than 170 amino acid sequences of serine proteases previously referred to as subtilisin-like proteases. A subtilisin was previously often defined as a serine protease produced by Gram-positive bacteria or fungi, and according to Siezen et al. now is a subgroup of subtilases. A wide variety of subtilases have been identified, and the amino acid sequence of a number of subtilases has been determined. For a more detailed description of such subtilases and their amino acid sequences reference is made to Siezen et al. (1997).

### Subtilisins

A subgroup of subtilases is subtilisins which are serine proteases from the family S8, in particular from the subfamily S8A, as defined by the MEROPS database (merops.sanger.ac.uk/cgi-bin/famsum?family=S8).

Subtilisin BPN′ and subtilisin 309 have the MEROPS numbers 508.034 and S08.003, respectively.

### Parent Subtilase

The term “parent subtilase” describes a subtilase defined according to Siezen et al., 1997, Protein Science 6: 501-523. For further details see description of “Subtilases” above. A parent subtilase may also be a subtilase isolated from a natural source, wherein subsequent modifications (such as replacement(s) of the amino acid side chain(s), substitution(s), deletion(s) and/or insertion(s)) have been made while retaining the characteristic of a subtilase. Furthermore, a parent subtilase may be a subtilase which has been prepared by the DNA shuffling technique.

Alternatively, the term “parent subtilase” may be termed “precursor subtilase” and is used to describe the starting protease into which mutations are made to obtain the variant of the present disclosure. The parent subtilase is preferably of the subtilisin subgroups.

One subgroup of the subtilases, I-S1 or “true” subtilisins, include the “classical” subtilisins, such as subtilisin 168 (BSS168), subtilisin BPN′, subtilisin Carlsberg (ALCALASE®, Novozymes A/S), and subtilisin DY (BSSDY). BPN′ is subtilisin BPN′ from B. amyloliquefaciens, Subtilisin BPN′ has the amino acid sequence of SEQ ID NO: 2. A further subgroup of the subtilases, I-S2 or high alkaline subtilisins, is recognized by Siezen et al. (supra). Sub-group I-S2 proteases are described as highly alkaline subtilisins and include enzymes such as subtilisin PB92 (BAALKP) (MAXACAL®, Genencor International Inc.), subtilisin 147 (BLS147) (ESPERASE®, Novozymes A/S), alkaline elastase YaB (BSEYAB) and subtilisin 309 (SAVINASE®, Novozymes A/S) having the amino acid sequence SEQ ID NO: 1.

For reference, Table 1 below gives a list of some acronyms for various subtilases mentioned herein. For further acronyms, see Siezen et al. (1991 and 1997).

TABLE 1
Acronyms of various subtilases

| Organism | Enzyme | Acronym | Sequence |
|---|---|---|---|
| Bacillus subtilis 168 | subtilisin | BSS168 | SEQ ID NO: 3 |
| | I168, apr | | |
| Bacillus | subtilisin | BASBPN | SEQ ID NO: 2 |
| amyloliquefaciens | BPN′ (NOVO) | | |
| Bacillus subtilis DY | subtilisin DY | BSSDY | SEQ ID NO: 4 |
| Bacillus | subtilisin | BLSCAR | SEQ ID NO: 5 |
| licheniformis | Carlsberg | | |
| Bacillus lentus | subtilisin 309 | BLSAVI | SEQ ID NO: 1 |
| Bacillus lentus | subtilisin 147 | BLS147 | SEQ ID NO: 6 |
| Bacillus alcalophilus | subtilisin | BAPB92 | SEQ ID NO: 7 |
| PB92 | PB92 | | |
| Bacillus YaB | alkaline | BYSYAB | SEQ ID NO: 8 |
| | elastase YaB | | |
| Bacillus sp. | subtilisin ALP I | BSAPRQ | SEQ ID NO: 9 |
| NKS-21 | | | |
| Bacillus sp. | subtilisin Sendai | BSAPRS | SEQ ID NO: 10 |
| G-825-6 | | | |
| Thermoactinomyces | Thermitase | TVTHER | SEQ ID NO: 11 |
| vulgaris | | | |

### Homologous Subtilase Sequences

The homology between two amino acid sequences is in this context described by the parameter “identity” for purposes of the present disclosure, the degree of identity between two amino acid sequences is determined using the Needleman-Wunsch algorithm as described above. The output from the routine is besides the amino acid alignment the calculation of the “Percent Identity” between the two sequences.

Based on the description it is routine for a person skilled in the art to identify suitable homologous subtilases, which can be modified as contemplated herein.

The parent protease may be a polypeptide having at least about 60% sequence identity to the polypeptide of SEQ ID NO: 1, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 1. In another aspect, the parent comprises or of the amino acid sequence of SEQ ID NO: 1.

The parent protease may be a polypeptide having at least about 60% sequence identity to the polypeptide of SEQ ID NO: 2, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 2. In another aspect, the parent comprises or of the amino acid sequence of SEQ ID NO: 2.

The parent protease may be a polypeptide having at least about 60% sequence identity to the polypeptide of SEQ ID NO: 3, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 3. In another aspect, the parent comprises or of the amino acid sequence of SEQ ID NO: 3.

The parent protease may be a polypeptide having at least about 60% sequence identity to the polypeptide of SEQ ID NO: 4, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 4. In another aspect, the parent comprises or of the amino acid sequence of SEQ ID NO: 4.

The parent protease may be a polypeptide having at least about 60% sequence identity to the polypeptide of SEQ ID NO: 5, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 5. In another aspect, the parent comprises or of the amino acid sequence of SEQ ID NO: 5.

The parent protease may be a polypeptide having at least about 60% sequence identity to the polypeptide of SEQ ID NO: 6, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 6. In another aspect, the parent comprises or of the amino acid sequence of SEQ ID NO: 6.

The parent protease may be a polypeptide having at least about 60% sequence identity to the polypeptide of SEQ ID NO: 7, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 7. In another aspect, the parent comprises or of the amino acid sequence of SEQ ID NO: 7.

The parent protease may be a polypeptide having at least about 60% sequence identity to the polypeptide of SEQ ID NO: 8, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 8. In another aspect, the parent comprises or of the amino acid sequence of SEQ ID NO: 8.

The parent protease may be a polypeptide having at least about 60% sequence identity to the polypeptide of SEQ ID NO: 9, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 9. In another aspect, the parent comprises or of the amino acid sequence of SEQ ID NO: 9.

The parent protease may be a polypeptide having at least about 60% sequence identity to the polypeptide of SEQ ID NO: 10, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 10. In another aspect, the parent comprises or of the amino acid sequence of SEQ ID NO: 10.

The parent protease may be a polypeptide having at least about 60% sequence identity to the polypeptide of SEQ ID NO: 11, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or 100%, which have protease activity. In one aspect, the amino acid sequence of the parent differs by up to 10 amino acids, e.g., 1, 2, 3, 4, 5, 6, 7, 8, 9, or 10, from the polypeptide of SEQ ID NO: 11. In another aspect, the parent comprises or of the amino acid sequence of SEQ ID NO: 11.

The polypeptide may be a hybrid polypeptide in which a region of one polypeptide is fused at the N-terminus or the C-terminus of a region of another polypeptide.

The parent subtilase may be obtained from microorganisms of any genus. For purposes of the present disclosure, the term “obtained from” as used herein in connection with a given source shall mean that the parent encoded by a polynucleotide is produced by the source or by a strain in which the polynucleotide from the source has been inserted. In one aspect, the parent is secreted extracellularly.

The parent may be a bacterial protease. For example, the parent may be a Gram-positive bacterial polypeptide such as a Bacillus, Clostridium, Enterococcus, Geobacillus, Lactobacillus, Lactococcus, Oceanobacillus, Staphylococcus, Streptococcus, or Streptomyces protease, or a Gram-negative bacterial polypeptide such as a Campylobacter, E. coli, Flavobacterium, Fusobacterium, Helicobacter, Ilyobacter, Neisseria, Pseudomonas, Salmonella, or Ureaplasma protease.

In one aspect, the parent is a Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, or Bacillus thuringiensis protease

Strains of these species are readily accessible to the public in a number of culture collections, such as the American Type Culture Collection (ATCC), Deutsche Sammlung von Mikroorganismen and Zellkulturen GmbH (DSMZ), Centraalbureau Voor Schimmelcultures (CBS), and Agricultural Research Service Patent Culture Collection, Northern Regional Research Center (NRRL).

The parent may be identified and obtained from other sources including microorganisms isolated from nature (e.g., soil, composts, water, etc.) or DNA samples obtained directly from natural materials (e.g., soil, composts, water, etc.) using the above-mentioned probes. Techniques for isolating microorganisms and DNA directly from natural habitats are well known in the art. A polynucleotide encoding a parent may then be obtained by similarly screening a genomic DNA or cDNA library of another microorganism or mixed DNA sample. Once a polynucleotide encoding a parent has been detected with the probe(s), the polynucleotide can be isolated or cloned by utilizing techniques that are known to those of ordinary skill in the art.

### Preparation of Detergent Composition Comprising Variants

The present disclosure also relates to a method for producing a detergent composition comprising a subtilase variant, comprising

(A) introducing into a parent subtilase a set of alterations selected from the group of:
(a) X167A+R170S+A194P (e.g., Y167A+R170S+A194P) and one or more substitutions selected from the group of X59D (e.g., Q59D), X62D (e.g., N62D), X76D (e.g., N76D), X104T (e.g., V104T), X120D (e.g., H120D), X133P (e.g. A133P), X141N (e.g. S141N), X156D (e.g., S156D), X163G (e.g., S163G), X209W (e.g., Y209W), X228V (e.g. A228V), X230V (e.g. A230V), X238E (e.g., N238E), X261D (e.g., N261D), and X262E (e.g., L262E);
(b) *99aE and one or more substitutions selected from the group of X21D (e.g L21D), X59D (e.g., Q59D), X101H (e.g., S101H), X120D (e.g., H120D), X156D (e.g., S156D), X163G (e.g., S163G), X194P (e.g., A194P), X195E (e.g., G195E), X209W (e.g., Y209W), X238E (e.g., N238E), X256D (e.g. N256D), X261D (e.g., N261D), and X262E (e.g., L262E);
(c) X62D (e.g., N62D) and one or more substitutions selected from the group of X101H (e.g., S101H), X104T (e.g., V104T), X156D (e.g., S156D), X163G (e.g., S163G), X170S, X170L (e.g., R170S, R170L), X209W (e.g., Y209W), X238E (e.g., N238E), X245R (e.g. Q245R) and X262E (e.g., L262E);
(d) X62D+X245R+X248D (e.g., N62D+Q245R+N248D) and one or more substitutions selected from the group of X156D (e.g., S156D), X163G (e.g., S163G), X163K (e.g., S163K), X170S (e.g., R170S), X209W (e.g., Y209W), and X262E (e.g., L262E);
(e) X170L, X170N, X170S (e.g. R170L, R170N, R170S) and one or more substitutions selected from the group of X57P (e.g. S57P), X167A (e.g. Y167A), X172E (e.g. A172E), X206E (e.g. Q206E),
(f) X99D (e.g. S99D) and one or more substitutions selected from the group of *97aN, *98aA, X98T (e.g. A98T), X261D (e.g., N261D), and X262Q (e.g., L262Q);
wherein
(i) the positions correspond to the positions of the polypeptide of SEQ ID NO: 2;
(ii) the variant has protease activity; and
(iii) the variant has at least about 60%, e.g., at least about 65%, at least about 70%, at least about 75%, at least about 80%, at least about 85%, at least about 90%, at least about 95%, at least about 96%, at least about 97%, at least about 98% but less than 100% sequence identity to the polypeptide of SEQ ID NO: 1, 2, 3, 4, 5, 6, 7, 8, 9, 10 or 11; and
(B) recovering the variant
(C) adding the variant to a detergent composition.

The variants can be prepared using any mutagenesis procedure known in the art, such as site-directed mutagenesis, synthetic gene construction, semi-synthetic gene construction, random mutagenesis, shuffling, etc.

Site-directed mutagenesis is a technique in which one or more (e.g., several) mutations are introduced at one or more defined sites in a polynucleotide encoding the parent.

Site-directed mutagenesis can be accomplished in vitro by PCR involving the use of oligonucleotide primers containing the desired mutation. Site-directed mutagenesis can also be performed in vitro by cassette mutagenesis involving the cleavage by a restriction enzyme at a site in the plasmid comprising a polynucleotide encoding the parent and subsequent ligation of an oligonucleotide containing the mutation in the polynucleotide. Usually the restriction enzyme that digests the plasmid and the oligonucleotide is the same, permitting sticky ends of the plasmid and the insert to ligate to one another.

Site-directed mutagenesis can also be accomplished in vivo by methods known in the art.

Any site-directed mutagenesis procedure can be used in the present disclosure. There are many commercial kits available that can be used to prepare variants.

Synthetic gene construction entails in vitro synthesis of a designed polynucleotide molecule to encode a polypeptide of interest. Gene synthesis can be performed utilizing a number of techniques, such as the multiplex microchip-based technology and similar technologies wherein oligonucleotides are synthesized and assembled upon photo-programmable microfluidic chips.

Single or multiple amino acid substitutions, deletions, and/or insertions can be made and tested using known methods of mutagenesis, recombination, and/or shuffling, followed by a relevant screening procedure, such as those disclosed by WO 95/17413 or WO 95/22625. Other methods that can be used include error-prone PCR, phage display and region-directed mutagenesis.

Mutagenesis/shuffling methods can be combined with high-throughput, automated screening methods to detect activity of cloned, mutagenized polypeptides expressed by host cells. Mutagenized DNA molecules that encode active polypeptides can be recovered from the host cells and rapidly sequenced using standard methods in the art. These methods allow the rapid determination of the importance of individual amino acid residues in a polypeptide.

Semi-synthetic gene construction is accomplished by combining aspects of synthetic gene construction, and/or site-directed mutagenesis, and/or random mutagenesis, and/or shuffling. Semi-synthetic construction is typified by a process utilizing polynucleotide fragments that are synthesized, in combination with PCR techniques. Defined regions of genes may thus be synthesized de novo, while other regions may be amplified using site-specific mutagenic primers, while yet other regions may be subjected to error-prone PCR or non-error prone PCR amplification. Polynucleotide subsequences may then be shuffled.

### Compositions

The present disclosure relates to a detergent composition comprising a subtilase variant.

The choice of additional components comprised in the detergent composition is within the skill of the artisan and includes conventional ingredients, including the exemplary non-limiting components set forth below. The choice of components may include, components useful for fabric care, the consideration of the type of fabric to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the person skilled in the art.

In a particular embodiment, the detergent composition of the present disclosure comprises a subtilase variant as described herein and one or more detergent components, such as surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, optical brighteners, bactericides, fungicides, soil suspending agents, soil release polymers, anti-redeposition agents, enzyme inhibitors or stabilizers, enzyme activators, antioxidants, and solubilizers.

In one embodiment of the present disclosure, the subtilase variant may be added to the detergent composition in an amount corresponding to from about 0.01 to about 200 mg of enzyme protein per liter of wash liquor, preferably from about 0.05 to about 50 mg of enzyme protein per liter of wash liquor, in particular from about 0.1 to about 10 mg of enzyme protein per liter of wash liquor.

A composition for use in automatic dishwash (ADW), for example, may include from about 0.0001% to about 50%, such as from about 0.001% to about 30%, such as from about 0.01% to about 20%, such as from about 0.5 to about 15% of enzyme protein by weight of the composition.

A composition for use in laundry granulation, for example, may include from about 0.0001% to about 50%, such as from about 0.001% to about 20%, such as from about 0.01% to about 10%, such as from about 0.05% to about 5% of enzyme protein by weight of the composition.

A composition for use in laundry liquid, for example, may include from about 0.0001% to about 10%, such as from about 0.001 to about 7%, such as from about 0.1% to about 5% of enzyme protein by weight of the composition.

The enzymes such as the subtilase variant of the present disclosure may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in, for example, WO 92/19709 and WO 92/19708 or the variants as contemplated herein may be stabilized using peptide aldehydes or ketones such as described in WO 2005/105826 and WO 2009/118375.

A variant of the present disclosure may also be incorporated in the detergent formulations disclosed in WO 97/07202, which is hereby incorporated by reference.

### Surfactants

The detergent composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 0.1% to about 60% by weight, such as from about 1% to about 40%, or from about 3% to about 20%, or from about 3% to about 10%. The surfactant(s) is chosen based on the desired cleaning application, and includes any conventional surfactant(s) known in the art. Any surfactant known in the art for use in detergents may be utilized. Surfactants lower the surface tension in the detergent, which allows the stain being cleaned to be lifted and dispersed and then washed away.

When included therein the detergent will usually contain from about 1% to about 40% by weight, such as from about 5% to about 30%, including from about 5% to about 15%, or from about 20% to about 25% of an anionic surfactant. Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

When included therein the detergent will usually contain from about 0% to about 10% by weight of a cationic surfactant. Non-limiting examples of cationic surfactants include alklydimethylethanolamine quat (ADMEAQ), cetyltrimethylammonium bromide (CTAB), dimethyldistearylammonium chloride (DSDMAC), and alkylbenzyldimethyl ammonium, alkyl quaternary ammonium compounds, alkoxylated quaternary ammonium (AQA) compounds, and combinations thereof.

When included therein the detergent will usually contain from about 0.2% to about 40% by weight of a non-ionic surfactant, for example from about 0.5% to about 30%, in particular from about 1% to about 20%, from about 3% to about 10%, such as from about 3% to about 5%, or from about 8% to about 12%. Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

When included therein the detergent will usually contain from about 0% to about 10% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

When included therein the detergent will usually contain from about 0% to about 10% by weight of a zwitterionic surfactant. Non-limiting examples of zwitterionic surfactants include betaine, alkyldimethylbetaine, sulfobetaine, and combinations thereof.

### Hydrotropes

A hydrotrope is a compound that solubilizes hydrophobic compounds in aqueous solutions (or oppositely, polar substances in a non-polar environment). Typically, hydrotropes have both hydrophilic and hydrophobic characters (so-called amphiphilic properties as known from surfactants); however the molecular structure of hydrotropes generally do not favor spontaneous self-aggregation. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allows for example more concentrated formulations of surfactants (as in the process of compacting liquid detergents by removing water) without inducing undesired phenomena such as phase separation or high viscosity.

The detergent may contain from 0 to about 5% by weight, such as from about 0.5 to about 5%, or from about 3% to about 5%, of a hydrotrope. Any hydrotrope known in the art for use in detergents may be utilized. Non-limiting examples of hydrotropes include sodium benzene sulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain from 0 to about 65% by weight, such as from about 5% to about 45% of a detergent builder or co-builder, or a mixture thereof. In a dish wash detergent, the level of builder is typically from about 40 to about 65%, particularly from about 50 to about 65%. Builders and chelators soften, e.g., the wash water by removing the metal ions form the liquid. The builder and/or co-builder may particularly be a chelating agent that forms water-soluble complexes with Ca and Mg. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as iminodiethanol), triethanolamine (TEA, also known as 2,2′,2″-nitrilotriethanol), and carboxymethyl inulin (CMI), and combinations thereof.

The detergent composition may also contain from 0 to about 20% by weight, such as from about 5% to about 10%, of a detergent co-builder, or a mixture thereof. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-di succinic acid (EDDS), methylglycinediacetic acid (MGDA), glutamic acid-N,N-diacetic acid (GLDA), 1-hydroxyethane-1,1-diphosphonic acid (HEDP), ethylenediaminetetra-(methylenephosphonic acid) (EDTMPA), diethylenetriaminepentakis (methylenephosphonic acid) (DTPMPA or DTMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N, N-diacetic acid (α-ALDA), serine-N, N-diacetic acid (SEDA), isoserine-N, N-diacetic acid (ISDA), phenylalanine-N, N-diacetic acid (PHDA), anthranilic acid-N, N-diacetic acid (ANDA), sulfanilic acid-N, N-diacetic acid (SLDA), taurine-N, N-diacetic acid (TUDA) and sulfomethyl-N, N-diacetic acid (SMDA), N-(2-hydroxyethyl)-ethylidenediamine-N, N′, N′-triacetate (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 2009/102854 and U.S. Pat. No. 5,977,053

### Bleaching Systems

The detergent may contain from 0 to about 50% by weight, such as from about 0.1% to about 25%, of a bleaching system. Bleach systems remove discolor often by oxidation, and many bleaches also have strong bactericidal properties, and are used for disinfecting and sterilizing. Any bleaching system known in the art for use in laundry detergents may be utilized. Suitable bleaching system components include bleaching catalysts, photobleaches, bleach activators, sources of hydrogen peroxide such as sodium percarbonate and sodium perborates, preformed peracids and mixtures thereof. Suitable preformed peracids include, but are not limited to, peroxycarboxylic acids and salts, percarbonic acids and salts, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with peroxygen bleach like hydrogen peroxide to form a peracid. The peracid thus formed constitutes the activated bleach. Suitable bleach activators to be used herein include those belonging to the class of esters amides, imides or anhydrides. Suitable examples are tetracetylethylene diamine (TAED), sodium 4-[(3,5,5-trimethylhexanoyl)oxy]benzene sulfonate (ISONOBS), diperoxy dodecanoic acid, 4-(dodecanoyloxy)benzenesulfonate (LOBS), 4-(decanoyloxy)benzenesulfonate, 4-(decanoyloxy)benzoate (DOB S), 4-(nonanoyloxy)-benzenesulfonate (NOBS), and/or those disclosed in WO 98/17767. A particular family of bleach activators of interest was disclosed in EP 624154 and particulary preferred in that family is acetyl triethyl citrate (ATC). ATC or a short chain triglyceride like triacetin has the advantage that it is environmental friendly as it eventually degrades into citric acid and alcohol. Furthermore acetyl triethyl citrate and triacetin has a good hydrolytical stability in the product upon storage and it is an efficient bleach activator. Finally ATC provides a good building capacity to the laundry additive. Alternatively, the bleaching system may comprise peroxyacids of, for example, the amide, imide, or sulfone type. The bleaching system may also comprise peracids such as 6-(phthalimido)peroxyhexanoic acid (PAP). The bleaching system may also include a bleach catalyst. In some embodiments the bleach component may be an organic catalyst selected from the group of organic catalysts having the following formula:

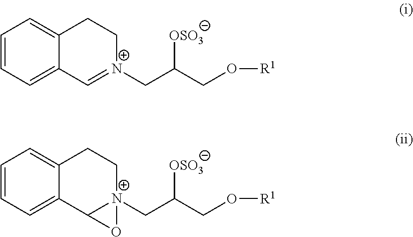

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Other exemplary bleaching systems are described, e.g., in WO 2007/087258, WO 2007/087244, WO 2007/087259 and WO 2007/087242. Suitable photobleaches may for example be sulfonated zinc phthalocyanine.

Polymers

The detergent may contain from 0 to about 10% by weight, such as from about 0.5 to about 5%, from about 2 to about 5%, from about 0.5 to about 2% or from about 0.2 to about 1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Fabric Hueing Agents

The detergent compositions of the present disclosure may also include fabric hueing agents such as dyes or pigments, which when formulated in detergent compositions can deposit onto a fabric when the fabric is contacted with a wash liquor comprising the detergent compositions and thus altering the tint of the fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO 2005/003274, WO 2005/003275, WO 2005/003276 and EP 1876226 (hereby incorporated by reference). The detergent composition preferably comprises from about 0.00003 wt. % to about 0.2 wt. %, from about 0.00008 wt. % to about 0.05 wt. %, or even from about 0.0001 wt. % to about 0.04 wt. % fabric hueing agent. The composition may comprise from about 0.0001 wt % to about 0.2 wt. % fabric hueing agent, this may be especially preferred when the composition is in the form of a unit dose pouch. Suitable hueing agents are also disclosed in, e.g., WO 2007/087257 and WO 2007/087243.

### Additional Enzymes

The detergent additive as well as the detergent composition may comprise one or more (additional) enzymes such as an amylase, arabinase, carbohydrase, cellulase (e.g., endoglucanase), cutinase, galactanase, haloperoxygenase, lipase, mannanase, oxidase, e.g., laccase and/or peroxidase, pectinase, pectin lyases, protease, xylanase, xanthanase, and xyloglucanase.

In general the properties of the selected enzyme(s) should be compatible with the selected detergent (i.e., pH-optimum, compatibility with other enzymatic and non-enzymatic ingredients, etc.), and the enzyme(s) should be present in effective amounts.

### Cellulases

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having color care benefits. Examples of such cellulases are cellulases described in EP 495257, EP 531372, WO 96/11262, WO 96/29397, WO 98/08940. Other examples are cellulase variants such as those described in WO 94/07998, EP 531315, U.S. Pat. No. 5,457,046, U.S. Pat. No. 5,686,593, U.S. Pat. No. 5,763,254, WO 95/24471, WO 98/12307 and PCT/DK98/00299.

Examples of cellulases exhibiting endo-beta-1,4-glucanase activity (EC 3.2.1.4) are described in WO 02/99091.

Other examples of cellulases include the family 45 cellulases described in WO 96/29397, and especially variants thereof having substitution, insertion and/or deletion at one or more of the positions corresponding to the following positions in SEQ ID NO: 8 of WO 02/99091: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, preferably selected among P19A, G20K, Q44K, N48E, Q119H or Q146 R.

Commercially available cellulases include Celluzyme™, and Carezyme™ (Novozymes A/S), Clazinase™, and Puradax HA™ (Genencor International Inc.), and KAC-500(B)™ (Kao Corporation).

### Proteases

The composition may comprise one or more additional proteases including those of bacterial, fungal, plant, viral or animal origin, e.g., vegetable or microbial origin. Microbial origin is preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from, e.g., family M4 or other metalloprotease such as those from M5, M7 or M8 families.

Examples of metalloproteases are the neutral metalloprotease as described in WO 2007/044993 (Genencor Int.) such as those derived from Bacillus amyloliquefaciens.

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® (Novozymes A/S), those sold under the tradename Maxatase®, Maxacal®, Maxapem®, Purafect®, Purafect Prime®, Purafect MA®, Purafect Ox®, Purafect OxP®, Puramax®, Properase®, FN2®, FN3®, FN4®, Excellase®, Eraser®, Opticlean® and Optimase® (Danisco/DuPont), Axapem™ (Gist-Brocades N.V.), BLAP (sequence shown in FIG. 29 of U.S. Pat. No. 5,352,604) and variants hereof (Henkel AG) and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g., from T. lanuginosus (previously named Humicola lanuginosa) as described in EP 258068 and EP 305216, cutinase from Humicola, e.g., H. insolens (WO 96/13580), lipase from strains of Pseudomonas (some of these now renamed to Burkholderia), e.g., P. alcaligenes or P. pseudoalcaligenes (EP 218272), P. cepacia (EP 331376), P. sp. strain SD705 (WO 95/06720 & WO 96/27002), P. wisconsinensis (WO 96/12012), GDSL-type Streptomyces lipases (WO 2010/065455), cutinase from Magnaporthe grisea (WO 2010/107560), cutinase from Pseudomonas mendocina (U.S. Pat. No. 5,389,536), lipase from Thermobifida fusca (WO 2011/084412), Geobacillus stearothermophilus lipase (WO 2011/084417), lipase from Bacillus subtilis (WO 2011/084599), and lipase from Streptomyces griseus (WO 2011/150157) and S. pristinaespiralis (WO 2012/137147).

Other examples are lipase variants such as those described in EP 407225, WO 92/05249, WO 94/01541, WO 94/25578, WO 95/14783, WO 95/30744, WO 95/35381, WO 95/22615, WO 96/00292, WO 97/04079, WO 97/07202, WO 00/34450, WO 00/60063, WO 01/92502, WO 2007/87508 and WO 2009/109500.

Preferred commercial lipase products include Lipolase™, Lipex™; Lipolex™ and Lipoclean™ (Novozymes A/S), Lumafast (originally from Genencor) and Lipomax (originally from Gist-Brocades).

Still other examples are lipases sometimes referred to as acyltransferases or perhydrolases, e.g., acyltransferases with homology to Candida antarctica lipase A (WO 2010/111143), acyltransferase from Mycobacterium smegmatis (WO 2005/056782), perhydrolases from the CE 7 family (WO 2009/067279), and variants of the M. smegmatis perhydrolase in particular the S54V variant used in the commercial product Gentle Power Bleach from Huntsman Textile Effects Pte Ltd (WO 2010/100028).

### Amylases

Suitable amylases which can be used together with the subtilase variants of the present disclosure may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/19467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/10355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, I201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

### M197T;

### H156Y+A181T+N190F+A209V+Q264S; or

### G48A+T491+G107A+H156Y+A181 T+N190F+I201F+A209V+Q264 S.

Other suitable amylases are amylases having the sequence of SEQ ID NO: 6 in WO 99/19467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/23873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/23873 for numbering. More preferred variants are those having a deletion in two positions selected from 181, 182, 183 and 184, such as 181 and 182, 182 and 183, or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 2008/153815, SEQ ID NO: 10 in WO 01/66712 or variants thereof having 90% sequence identity to SEQ ID NO: 2 of WO 2008/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 2009/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, 5181, T182, G183, M201, F202, N225, 5243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or 5181 or of T182 and/or G183. Most preferred amylase variants of SEQ ID NO: 2 are those having the substitutions:

### S125A+N128C+T131I+T165I+K178L+T182G+Y305R+G475K;

### S125A+N128C+K178L+T182G+Y305R+G475K;

### N128C+K178L+T182G+F202Y+Y305R+D319T+G475K;

### N128C+K178L+T182G+Y305R+G475K;

wherein the variants are C-terminally truncated and optionally further comprise a substitution at position 243 and/or a deletion at position 180 and/or position 181.

Further suitable amylases are amylases having SEQ ID NO: 1 of WO 2013/184577 or variants having 90% sequence identity to SEQ ID NO: 1 thereof. Preferred variants of SEQ ID NO: 1 are those having a substitution, a deletion or an insertion in one of more of the following positions: K176, R178, G179, T180, G181, E187, N192, M199, 1203, 5241, R458, T459, D460, G476 and G477. More preferred variants of SEQ ID NO: 1 are those having the substitution in one of more of the following positions: K176L, E187P, N192FYH, M199L, I203YF, S241QADN, R458N, T459S, D460T, G476K and G477K and/or a deletion in position R178 and/or 5179 or of T180 and/or G181. Most preferred amylase variants of SEQ ID NO: 1 comprise the substitutions:

### E187P+I203Y+R458N+T459S+D460T+G476K

### E187P+I203Y+G476K

and optionally further comprise a substitution at position 241 and/or a deletion at position 178 and/or position 179.

Further suitable amylases are amylases having SEQ ID NO: 1 of WO 2010/104675 or variants having about 90% sequence identity to SEQ ID NO: 1 thereof. Preferred variants of SEQ ID NO: 1 are those having a substitution, a deletion or an insertion in one of more of the following positions: N21, D97, V128 K177, R179, 5180, 1181, G182, M200, L204, E242, G477 and G478. More preferred variants of SEQ ID NO: 1 are those having the substitution in one of more of the following positions: N21D, D97N, V128I K177L, M200L, L204YF, E242QA, G477K and G478K and/or a deletion in position R179 and/or 5180 or of 1181 and/or G182. Most preferred amylase variants of SEQ ID NO: 1 comprise the substitutions N21D+D97N+V128I, and optionally further comprise a substitution at position 200 and/or a deletion at position 180 and/or position 181.

Other suitable amylases are the alpha-amylase having SEQ ID NO: 12 in WO 01/66712 or a variant having at least about 90% sequence identity to SEQ ID NO: 12. Preferred amylase variants are those having a substitution, a deletion or an insertion in one of more of the following positions of SEQ ID NO: 12 in WO 01/66712: R28, R118, N174; R181, G182, D183, G184, G186, W189, N195, M202, Y298, N299, K302, 5303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO 2011/098531, WO 2013/001078 and WO 2013/001087. Commercially available amylases are Duramyl™, Termamyl™, Fungamyl™, Stainzyme™, Stainzyme Plus™, Natalase™, Liquozyme X and BAN™ (from Novozymes A/S), and Rapidase™, Purastar™/Effectenz™, Powerase, Preferenz S1000, Preferenz S100 and Preferenz S110 (from Genencor International Inc./DuPont).

### Peroxidases/Oxidases

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include Guardzyme™ (Novozymes A/S).

The detergent enzyme(s) may be included in a detergent composition by adding separate additives containing one or more enzymes, or by adding a combined additive comprising all of these enzymes. A detergent additive of the present disclosure, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g., as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of from about 1000 to about 20000; ethoxylated nonylphenols having from about 16 to about 50 ethylene oxide units; ethoxylated fatty alcohols in which the alcohol contains from about 12 to about 20 carbon atoms and in which there are from about 15 to about 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238216.

### Adjunct Materials

Any detergent components known in the art for use in laundry detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

### Dispersants

The detergent compositions of the present disclosure can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Dye Transfer Inhibiting Agents

The detergent compositions of the present disclosure may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Fluorescent Whitening Agent

The detergent compositions of the present disclosure will preferably also contain additional components that may tint articles being cleaned, such as fluorescent whitening agent or optical brighteners. Where present the brightener is preferably at a level of from about 0.01% to about 05%. Any fluorescent whitening agent suitable for use in a laundry detergent composition may be used in the composition of the present disclosure. The most commonly used fluorescent whitening agents are those belonging to the classes of diaminostilbene-sulphonic acid derivatives, diarylpyrazoline derivatives and bisphenyl-distyryl derivatives. Examples of the diaminostilbene-sulphonic acid derivative type of fluorescent whitening agents include the sodium salts of: 4,4′-bis-(2-diethanolamino-4-anilino-s-triazin-6-ylamino) stilbene-2,2′-disulphonate; 4,4′-bis-(2,4-dianilino-s-triazin-6-ylamino) stilbene-2.2′-disulphonate; 4,4′-bis-(2-anilino-4(N-methyl-N-2-hydroxy-ethylamino)-s-triazin-6-ylamino) stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino) stilbene-2,2′-disulphonate and 2-(stilbyl-4″-naptho-1,2′:4,5)-1,2,3-trizole-2″-sulphonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4 anilino-s-triazin-6-ylamino) stilbene disulphonate. Tinopal CBS is the disodium salt of 2,2′-bis-(phenyl-styryl) disulphonate. Also preferred are fluorescent whitening agents is the commercially available Parawhite KX, supplied by Paramount Minerals and Chemicals, Mumbai, India. Other fluorescers suitable for use in the present disclosure include the 1-3-diaryl pyrazolines and the 7-alkylaminocoumarins. Suitable fluorescent brightener levels include lower levels of from about 0.01, from about 0.05, from about 0.1 or even from about 0.2 wt. % to upper levels of about 0.5 or even about 0.75 wt. %.

### Soil Release Polymers

The detergent compositions of the present disclosure may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 03/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

### Anti-Redeposition Agents

The detergent compositions of the present disclosure may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

### Other Suitable Adjunct Materials

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Detergent Products

The detergent composition of the present disclosure may be in any convenient form, e.g., a bar, a homogenous tablet, a tablet having two or more layers, a pouch having one or more compartments, a regular or compact powder, a granule, a paste, a gel, or a regular, compact or concentrated liquid. There are a number of detergent formulation forms such as layers (same or different phases), pouches, as well as forms for machine dosing unit.

Pouches can be configured as single or multicompartments. It can be of any form, shape and material which is suitable for hold the composition, e.g., without allowing the release of the composition from the pouch prior to water contact. The pouch is made from water soluble film which encloses an inner volume. The inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxyprpyl methyl cellulose (HPMC). Preferably the level of polymer in the film for example PVA is at least about 60%. Preferred average molecular weight will typically be about 20,000 to about 150,000. Films can also be of blend compositions comprising hydrolytically degradable and water soluble polymer blends such as polyactide and polyvinyl alcohol (known under the Trade reference M8630 as sold by Chris Craft In. Prod. of Gary, Ind., US) plus plasticisers like glycerol, ethylene glycerol, Propylene glycol, sorbitol and mixtures thereof. The pouches can comprise a solid laundry detergent composition or part components and/or a liquid cleaning composition or part components separated by the water soluble film. The compartment for liquid components can be different in composition than compartments containing solids. See, e.g., US 2009/0011970.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least about 20% by weight and up to about 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from about 0-about 30% organic solvent. A liquid or gel detergent may be non-aqueous.

### Laundry Soap Bars

The enzymes of the present disclosure may be added to laundry soap bars and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e., if a solid object (e.g., laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄⁺ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants, e.g., anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as but not limited to: mixers, plodders, e.g., a two stage vacuum plodder, extruders, cutters, logo-stampers, cooling tunnels and wrappers. The present disclosure is not limited to preparing the laundry soap bars by any single method. The premix of the present disclosure may be added to the soap at different stages of the process. For example, the premix containing a soap, an enzyme, optionally one or more additional enzymes, a protease inhibitor, and a salt of a monovalent cation and an organic anion may be prepared and the mixture is then plodded. The enzyme and optional additional enzymes may be added at the same time as the protease inhibitor for example in liquid form. Besides the mixing step and the plodding step, the process may further comprise the steps of milling, extruding, cutting, stamping, cooling and/or wrapping.

### Granular Detergent Formulations

A granular detergent may be formulated as described in WO 2009/092699, EP 1705241, EP 1382668, WO 2007/001262, U.S. Pat. No. 6,472,364, WO 2004/074419 or WO 2009/102854. Other detergent formulations are described in WO 2009/124162, WO 2009/124163, WO 2009/117340, WO 2009/117341, WO 2009/117342, WO 2009/072069, WO 2009/063355, WO 2009/132870, WO 2009/121757, WO 2009/112296, WO 2009/112298, WO 2009/103822, WO 2009/087033, WO 2009/050026, WO 2009/047125, WO 2009/047126, WO 2009/047127, WO 2009/047128, WO 2009/021784, WO 2009/010375, WO 2009/000605, WO 2009/122125, WO 2009/095645, WO 2009/040544, WO 2009/040545, WO 2009/024780, WO 2009/004295, WO 2009/004294, WO 2009/121725, WO 2009/115391, WO 2009/115392, WO 2009/074398, WO 2009/074403, WO 2009/068501, WO 2009/065770, WO 2009/021813, WO 2009/030632, WO 2009/015951, WO 2011/025615, WO 2011/016958, WO 2011/005803, WO 2011/005623, WO 2011/005730, WO 2011/005844, WO 2011/005904, WO 2011/005630, WO 2011/005830, WO 2011/005912, WO 2011/005905, WO 2011/005910, WO 2011/005813, WO 2010/135238, WO 2010/120863, WO 2010/108002, WO 2010/111365, WO 2010/108000, WO 2010/107635, WO 2010/090915, WO 2010/033976, WO 2010/033746, WO 2010/033747, WO 2010/033897, WO 2010/033979, WO 2010/030540, WO 2010/030541, WO 2010/030539, WO 2010/024467, WO 2010/024469, WO 2010/024470, WO 2010/025161, WO 2010/014395, WO 2010/044905, WO 2010/145887, WO 2010/142503, WO 2010/122051, WO 2010/102861, WO 2010/099997, WO 2010/084039, WO 2010/076292, WO 2010/069742, WO 2010/069718, WO 2010/069957, WO 2010/057784, WO 2010/054986, WO 2010/018043, WO 2010/003783, WO 2010/003792, WO 2011/023716, WO 2010/142539, WO 2010/118959, WO 2010/115813, WO 2010/105942, WO 2010/105961, WO 2010/105962, WO 2010/094356, WO 2010/084203, WO 2010/078979, WO 2010/072456, WO 2010/069905, WO 2010/076165, WO 2010/072603, WO 2010/066486, WO 2010/066631, WO 2010/066632, WO 2010/063689, WO 2010/060821, WO 2010/049187, WO 2010/031607, and WO 2010/000636.

### Uses

The present disclosure is also directed to methods for using the compositions as contemplated herein in laundering of textile and fabrics, such as house hold laundry washing and industrial laundry washing.

The present disclosure is also directed to methods for using the compositions as contemplated herein in cleaning hard surfaces such as floors, tables, walls, roofs etc. as well as surfaces of hard objects such as cars (car wash) and dishes (dish wash).

One aspect of the present disclosure relates to the use of the composition of the present disclosure in a cleaning process such as laundering and/or hard surface cleaning.

A detergent composition of the present disclosure may be formulated, for example, as a hand or machine laundry detergent composition including a laundry additive composition suitable for pre-treatment of stained fabrics and a rinse added fabric softener composition, or be formulated as a detergent composition for use in general household hard surface cleaning operations, or be formulated for hand or machine dishwashing operations.

In a specific aspect, the present disclosure provides a detergent additive comprising a polypeptide of the present disclosure as described herein.

The cleaning process or the textile care process may for example be a laundry process, a dishwashing process or cleaning of hard surfaces such as bathroom tiles, floors, table tops, drains, sinks and washbasins. Laundry processes can for example be household laundering, but it may also be industrial laundering. Furthermore, the present disclosure relates to a process for laundering of fabrics and/or garments where the process comprises treating fabrics with a washing solution containing a detergent composition, and at least one protease variant of the present disclosure. The cleaning process or a textile care process can for example be carried out in a machine washing process or in a manual washing process. The washing solution can for example be an aqueous washing solution containing a detergent composition.

The last few years there has been an increasing interest in replacing components in detergents, which is derived from petrochemicals with renewable biological components such as enzymes and polypeptides without compromising the wash performance. When the components of detergent compositions change new enzyme activities or new enzymes having alternative and/or improved properties compared to the common used detergent enzymes such as proteases, lipases and amylases is needed to achieve a similar or improved wash performance when compared to the traditional detergent compositions.

The present disclosure further concerns the use of compositions of the present disclosure comprising the subtilase in a proteinaceous stain removing processes. The proteinaceous stains may be stains such as, e.g., baby food, sebum, cocoa, egg, blood, milk, ink, grass, or a combination thereof.

Typical detergent compositions include various components in addition to the enzymes, these components have different effects, some components like the surfactants lower the surface tension in the detergent, which allows the stain being cleaned to be lifted and dispersed and then washed away, other components like bleach systems remove discolor often by oxidation and many bleaches also have strong bactericidal properties, and are used for disinfecting and sterilizing. Yet other components like builder and chelator softens, e.g., the wash water by removing the metal ions form the liquid.

In a particular embodiment, the present disclosure concerns the use of a composition comprising a subtilase variant and one or more detergent components, such as surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, optical brighteners, bactericides, fungicides, soil suspending agents, soil release polymers, anti-redeposition agents, enzyme inhibitors or stabilizers, enzyme activators, antioxidants, and solubilizers.

In a particular embodiment, the present disclosure concerns the use of a composition of the present disclosure comprising a subtilase variant as disclosed herein and one or more additional enzymes selected from the group comprising of proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a particular embodiment, the present disclosure concerns the use of a composition of the present disclosure comprising a subtilase variant as disclosed herein, one or more additional enzymes selected from the group comprising of proteases, amylases, lipases, cutinases, cellulases, endoglucanases, xyloglucanases, pectinases, pectin lyases, xanthanases, peroxidaes, haloperoxygenases, catalases and mannanases, or any mixture thereof and one or more detergent components, such as surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, optical brighteners, bactericides, fungicides, soil suspending agents, soil release polymers, anti-redeposition agents, enzyme inhibitors or stabilizers, enzyme activators, antioxidants, and solubilizers.

### Washing Method

The present disclosure relates to a method of cleaning a fabric, a dishware or hard surface with a detergent composition of the present disclosure.

A preferred embodiment concerns a method of cleaning, the method comprising the steps of: contacting an object with a detergent composition of the present disclosure under conditions suitable for cleaning the object. In a preferred embodiment the detergent composition is used in a laundry or a dish wash process.

Still another embodiment relates to a method for removing stains from fabric or dishware which comprises contacting the fabric or dishware with a composition of the present disclosure under conditions suitable for cleaning the object.

Also contemplated are compositions and methods of treating fabrics (e.g., to desize a textile) using one or more of the protease of the present disclosure. The protease can be used in any fabric-treating method which is well known in the art (see, e.g., U.S. Pat. No. 6,077,316). For example, in one aspect, the feel and appearance of a fabric is improved by a method comprising contacting the fabric with a protease in a solution. In one aspect, the fabric is treated with the solution under pressure.

The detergent compositions of the present disclosure are suited for use in laundry and hard surface applications, including dish wash. Accordingly, the present disclosure includes a method for laundering a fabric or washing dishware. The method comprises the steps of contacting the fabric/dishware to be cleaned with a solution comprising the detergent composition as contemplated herein. The fabric may comprise any fabric capable of being laundered in normal consumer use conditions. The dishware may comprise any dishware such as crockery, cutlery, ceramics, plastics such as melamine, metals, china, glass and acrylics. The solution preferably has a pH from about 5.5 to about 11.5. The compositions may be employed at concentrations from about 100 ppm, preferably 500 ppm to about 15,000 ppm in solution. The water temperatures typically range from about 5° C. to about 95° C., including about 10° C., about 15° C., about 20° C., about 25° C., about 30° C., about 35° C., about 40° C., about 45° C., about 50° C., about 55° C., about 60° C., about 65° C., about 70° C., about 75° C., about 80° C., about 85° C. and about 90° C. The water to fabric ratio is typically from about 1:1 to about 30:1.

The enzyme(s) of the detergent composition of the present disclosure may be stabilized using conventional stabilizing agents and protease inhibitors, e.g., a polyol such as propylene glycol or glycerol, a sugar or sugar alcohol, different salts such as NaCl; KCl; lactic acid, formic acid, boric acid, or a boric acid derivative, e.g., an aromatic borate ester, or a phenyl boronic acid derivative such as 4-formylphenyl boronic acid, or a peptide aldehyde such as di-, tri- or tetrapeptide aldehydes or aldehyde analogues (either of the form B1-B0-R wherein, R is H, CH3, CX3, CHX2, or CH2X (X=halogen), B0 is a single amino acid residue (preferably with an optionally substituted aliphatic or aromatic side chain); and B1 of one or more amino acid residues (preferably one, two or three), optionally comprising an N-terminal protection group, or as described in WO 2009/118375, WO 98/13459) or a protease inhibitor of the protein type such as RASI, BASI, WASI (bifunctional alpha-amylase/subtilisin inhibitors of rice, barley and wheat) or Cl2 or SSI. The composition may be formulated as described in, e.g., WO 92/19709, WO 92/19708 and U.S. Pat. No. 6,472,364. In some embodiments, the enzymes employed herein are stabilized by the presence of water-soluble sources of zinc (II), calcium (II) and/or magnesium (II) ions in the finished compositions that provide such ions to the enzymes, as well as other metal ions (e.g., barium (II), scandium (II), iron (II), manganese (II), aluminum (III), Tin (II), cobalt (II), copper (II), Nickel (II), and oxovanadium (IV)).

In some preferred embodiments, the detergent compositions provided herein are typically formulated such that, during use in aqueous cleaning operations, the wash water has a pH of from about 5.0 to about 11.5, or in alternative embodiments, even from about 6.0 to about 10.5. In some preferred embodiments, granular or liquid laundry products are formulated to have a pH from about 6 to about 8. Techniques for controlling pH at recommended usage levels include the use of buffers, alkalis, acids, etc., and are well known to those skilled in the art.

The present disclosure is further described by the following examples that should not be construed as limiting the scope of the present disclosure.

### EXAMPLES

### Example 1: Construction of Variants by Site-Directed Mutagenesis

Site-directed variants were constructed of subtilisin 309 (SEQ ID NO: 1) comprising specific substitutions as contemplated herein. The variants were made by traditional cloning of DNA fragments (Sambrook et al., Molecular Cloning: A Laboratory Manual, 2nd Ed., Cold Spring Harbor, 1989) using PCR together with properly designed mutagenic oligonucleotides that introduced the desired mutations in the resulting sequence.

Mutagenic oligos were synthesized corresponding to the DNA sequence flanking the desired site(s) of mutation, separated by the DNA base pairs defining the insertions/deletions/substitutions. In this manner, the variants listed in Table 1 below were constructed and produced.

In order to test subtilisin 309 variants of the present disclosure, the mutated DNA comprising a variant of the present disclosure was transformed into a competent B. subtilis strain, fermented using standard protocols (PS-1 media, 3-4 days, 37° C.) and purified.

TABLE 1
Subtilisin 309 Variants

| Code | Mutations |
|---|---|
| A-000 | Y167A + R170S + A194P |
| A-001 | Q59D + Y167A + R170S + A194P + L262E |
| A-002 | Q59D + N76D + Y167A + R170S + A194P |
| A-003 | N76D + Y167A + R170S + A194P + N238E |
| A-004 | V104T + Y167A + R170S + A194P + Y209W + N238E + |
| | L262E |
| A-005 | V104T + H120D + S163G + Y167A + R170S + A194P + |
| | N261D |
| A-006 | V104T + S156D + Y167A + R170S + A194P + Y209W + |
| | L262E |
| A-007 | V104T + Y167A + R170S + A194P + N238E + L262E |
| A-008 | Q59D + Y167A + R170S + A194P + Y209W + L262E |
| B-000 | *99aE |
| B-001 | *99aE + N238E + L262E |
| B-002 | Q59D + *99aE + Y209W + L262E |
| B-003 | *99aE + B194P + G195E + L262E |
| B-004 | *99aE + S101H + H120D + S163G + N261D |
| B-005 | *99aE + S156D + Y209W + L262E |
| B-006 | *99aE + B194P + G195E + Y209W + L262E |
| C-000 | N62D + R170S |
| C-001 | N62D + S156D + S163G + Y209W + L262E |
| C-002 | N62D + R170S + Y209W + L262E |
| C-003 | N62D + R170S + N238E + L262E |
| C-004 | N62D + S156D + R170S + Y209W + L262E |
| C-005 | N62D + V104T + R170S + Y209W + L262E |
| C-006 | N62D + V104T + S156D + R170S + Y209W + L262E |
| C-007 | N62D + S101H + R170S + Y209W + L262E |
| D-000 | N62D + R170S + Q245R + N248D |
| D-001 | N62D + S156D + S163G + Y209W + Q245R + N248D + |
| | L262E |
| D-002 | N62D + R170S + Y209W + Q245R + N248D + |
| | L262E |
| D-003 | N62D + S156D + S163K + Y209W + Q245R + N248D + |
| | L262E |

### Example 2: Wash Testing of Variants by Automatic Mechanical Stress Assay (AMSA)

Washing experiments were performed in order to assess the wash performance of selected protease variants in laundry detergent. The proteases of the present application were tested using the Automatic Mechanical Stress Assay (AMSA). With the AMSA, the wash performance of many small volume enzyme-detergent solutions can be examined. The AMSA plate has a number of slots for test solutions and a lid that firmly squeezes a textile swatch to be washed against the slot openings. During the wash, the plate, test solutions, soiled textile swatch and lid are vigorously shaken to bring the test solution in contact with the soiled textile swatch and apply mechanical stress in a regular, periodic oscillating manner. For further description see WO 02/42740 especially the paragraph “Special method embodiments” at pages 23-24.

Model detergent and test materials were as provided in Table 2A:

TABLE 2A
Composition of model detergents and test materials

| | |
|---|---|
| Laundry | 0.3 to 0.5% xanthan gum, |
| liquid | 0.2 to 0.4% antifoaming agent, |
| model | 6 to 7% glycerol, 0.3 to 0.5% ethanol, |
| detergent | 4 to 7% FAEOS (fatty alcohol ether sulfate), |
| | 24 to 28% nonionic surfactants, |
| | 1% boric acid, 1 to 2% sodium citrate (dihydrate), |
| | 2 to 4% soda, 14 to 16% coconut fatty acid, |
| | 0.5% HEDP (1-hydroxyethane-(1,1-diphosphonic acid)), |
| | 0 to 0.4% PVP (polyvinylpyrrolidone), |
| | 0 to 0.05% optical brighteners, |
| | 0 to 0.001% dye, remainder deionized water. |

The experiment was conducted under the experimental conditions as specified in Table 2B below.

TABLE 2B
AMSA Experimental Conditions

| Detergent | Laundry liquid model detergent | |
|---|---|---|
| Detergent dosage | 4.66 | g/L |
| Test solution volume | 160 | μL |
| pH | 7.6 | |
| Wash time | 20 | minutes |
| Temperature | 20° | C. |
| Water hardness | 16° | dH |

| | |
|---|---|
| Enzyme concentration | 8.0 mg enzyme protein/L |
| in test solution | |
| Test material | Chocolate milk and soot swatch (PC-03) |

Water hardness was adjusted to 16° dH by addition of CaCl₂, MgCl₂, and NaHCO₃ (Ca²⁺:Mg²⁺:CO₃²⁻=5:1:6) to the test system. After washing the textile swatches were flushed in tap water and dried.

The performance of an enzyme variant was measured as the brightness of the color of the textile washed with that specific protease. Brightness can also be expressed as the intensity of the light reflected from the sample when illuminated with white light. When the sample is stained the intensity of the reflected light is lower, than that of a clean sample. Therefore the intensity of the reflected light can be used to measure wash performance of a protease. Color measurements were made with a professional flatbed scanner (EPSON EXPRESSION 10000XL, Atea A/S, Lautrupvang 6, 2750 Ballerup, Denmark), which was used to capture an image of the washed melamine tiles.

To extract a value for the light intensity from the scanned images, a special designed software application was used (Novozymes Colour Vector Analyzer). The program retrieves the 24 bit pixel values from the image and converts them into values for red, green and blue (RGB). The intensity value (Int) was calculated by adding the RGB values together as vectors and then taking the length of the resulting vector:

Int=\sqrt{r²+g²+b²}.

Textiles

Standard chocolate milk and soot textile swatches (PC-03) were obtained from the Center For Testmaterials BV, P.O. Box 120, 3133 KT Vlaardingen, the Netherlands.

The variants had a significantly better wash performance than the parent backbone.

TABLE 3
AMSA wash performance data for variants
relative to parent backbone (A-000).

| | | AMSA wash |
|---|---|---|
| | | performance |
| | | (relative to parent |
| Code | Mutations | backbone) |
| A-001 | Q59D + Y167A + R170S + A194P + | 1.2 |
| | L262E | |
| A-002 | Q59D + N76D + Y167A + R170S + | 1.1 |
| | A194P | |
| A-003 | N76D + Y167A + R170S + A194P + | 1.1 |
| | N238E | |
| A-004 | V104T + Y167A + R170S + A194P + | 1.1 |
| | Y209W + N238E + L262E | |
| A-005 | V104T + H120D + S163G + Y167A + | 1.1 |
| | R170S + A194P + N261D | |
| A-006 | V104T + S156D + Y167A + R170S + | 1.1 |
| | A194P + Y209W + L262E | |
| A-007 | V104T + Y167A + R170S + A194P + | 1.1 |
| | N238E + L262E | |
| A-008 | Q59D + Y167A + R170S + A194P + | 1.1 |
| | Y209W + L262E | |
| A-000 | Y167A + R170S + A194P | 1.0 |

TABLE 4
AMSA wash performance data for variants
relative to parent backbone (B-000).

| | | AMSA wash |
|---|---|---|
| | | performance |
| | | (relative to parent |
| Code | Mutations | backbone) |
| B-001 | *99aE + N238E + L262E | 1.1 |
| B-002 | Q59D + *99aE + Y209W + L262E | 1.1 |
| B-003 | *99aE + A194P + G195E + L262E | 1.1 |
| B-004 | *99aE + S101H + H120D + S163G + | 1.1 |
| | N261D | |
| B-005 | *99aE + S156D + Y209W + L262E | 1.1 |
| B-006 | *99aE + A194P + G195E + Y209W + | 1.1 |
| | L262E | |
| B-000 | *99aE | 1.0 |

TABLE 5
AMSA wash performance data for variants
relative to parent backbone (C-000).

| | | AMSA wash |
|---|---|---|
| | | performance |
| | | (relative to parent |
| Code | Mutations | backbone) |
| C-001 | N62D + S156D + S163G + Y209W + | 1.3 |
| | L262E | |
| C-002 | N62D + R170S + Y209W + L262E | 1.2 |
| C-003 | N62D + R170S + N238E + L262E | 1.2 |
| C-004 | N62D + S156D + R170S + Y209W + | 1.1 |
| | L262E | |
| C-005 | N62D + V104T + R170S + Y209W + | 1.1 |
| | L262E | |
| C-006 | N62D + V104T + S156D + R170S + | 1.1 |
| | Y209W + L262E | |
| C-007 | N62D + S101H + R170S + Y209W + | 1.1 |
| | L262E | |
| C-000 | N62D + R170S | 1.0 |

TABLE 6
AMSA wash performance data for variants
relative to parent backbone (D-000).

| | | AMSA wash |
|---|---|---|
| | | performance |
| | | (relative to parent |
| Code | Mutations | backbone) |
| D-001 | N62D + S156D + S163G + Y209W + | 1.2 |
| | Q245R + N248D + L262E | |
| D-002 | N62D + R170S + Y209W + Q245R + | 1.1 |
| | N248D + L262E | |
| D-003 | N62D + S156D + S163G + Y209W + | 1.1 |
| | Q245R + N248D + L262E | |
| D-000 | N62D + R170S + Q245R + N248D | 1.0 |

### Example 3

The wash performance of variants in detergents was determined by using the following standardized stains obtainable from CFT (Center for Testmaterials) B.V., Vlaardingen, Netherlands:

A: chocolate-milk/ink on cotton: product no. C3
B: chocolate-milk/ink on polyester/cotton: product no. PC3
C: blood-milk/ink on cotton: product no. C5
D: blood-milk/ink on polyester/cotton: product no. PC5
E: peanut oil pigment/ink on cotton: product no. C10
F: egg/pigment on cotton: product no. CS37

Furthermore the following stain obtainable from Eidgenössische Material- and Prüfanstalt (EMPA) was used:

G: grass on cotton: product no. 164

A liquid washing agent with the following composition was used as base formulation (all values in weight percent): from about 0 to about 0.5% xanthan gum, from about 0.2 to about 0.4% antifoaming agent, from about 0.2 to about 8% Triethanolamine, from about 1 to about 7% glycerol, from about 0.3 to about 3% ethanol, from about 0 to about 12% FAEOS (fatty alcohol ether sulfate), from about 1 to about 28% nonionic surfactants, from v0.5-about 4% boric acid, from about 0.5 to about 6% sodium citrate (dihydrate), from about 1 to about 6% soda, from about 0 to about 16% coconut fatty acid, from about 0.5 to about 6% HEDP (1-hydroxyethane-(1,1-diphosphonic acid)), from about 0 to about 0.4% PVP (polyvinylpyrrolidone), from about 0 to about 0.05% optical brighteners, from about 0 to about 0.001% dye, remainder deionized water.

Based on this base formulation, various detergents were prepared by adding respective proteases as indicated in table 7a) and b). Reference is the protease Subtilisin 309 that has the amino acid sequence as shown in SEQ ID NO.1, the reference protease already showing a good wash performance, especially in liquid detergents. The proteases were added in the same amounts based on total protein content (5 mg/l wash liquor).

The dosing ratio of the liquid washing agent was 4.7 grams per liter of washing liquor and the washing procedure was performed for 60 minutes at a temperature of 20° C. and 40° C., the water having a water hardness between about 15.5 and about 16.5° (German degrees of hardness).

The whiteness, i.e. the brightening of the stains, was determined photometrically as an indication of wash performance. A Minolta CM508d spectrometer device was used, which was calibrated beforehand using a white standard provided with the unit.

The results obtained are the difference values between the remission units obtained with the detergents and the remission units obtained with the detergent containing the reference protease. A positive value therefore indicates an improved wash performance of the variants in the detergent. It is evident from tables 7a (results at 40° C.) and 7b (results at 20° C.) that variants as contemplated herein show improved wash performance.

TABLE 7a
Wash performance at 40° C. of protease variants that have the
same amino acid sequence as SEQ ID NO: 1 except for the
substitutions as per the table below on the stains as indicated;
reference is the protease according to SEQ ID NO: 1.

| | A | B | C | D | E | F | G |
|---|---|---|---|---|---|---|---|
| *99aE, A194P | nd | nd | 5.4 | nd | nd | 8.3 | 1.7 |
| N76D, Y167A, | 1.5 | nd | 2.8 | nd | 0.5 | nd | 0.6 |
| R1705, A194P | | | | | | | |
| N76D, Y167A, R170S, | 2.4 | nd | 3.0 | nd | 1.0 | nd | nd |
| A194P, A228V, | | | | | | | |
| A230V | | | | | | | |
| *99aE, S256D | 1.5 | 0.9 | 4.1 | 6.6 | nd | 4.4 | nd |
| L21D, *99aE | nd | 0.8 | 5.2 | 6.7 | 0.7 | 5.0 | nd |
| N62D, Q245R, | 0.6 | 0.7 | 5.5 | 7.7 | 0.5 | 1.5 | 0.5 |
| R170S | | | | | | | |
| R170L, Q206E, S57P | 2.0 | 0.9 | 4.9 | 6.3 | 1.2 | 1.2 | 0.9 |
| A133P, Y167A, | nd | nd | 3.5 | 5.5 | 1.1 | nd | 1.3 |
| R170, A194P | | | | | | | |
| S141N, Y167A, | 1.4 | 0.8 | 5.1 | 5.5 | nd | nd | 1.3 |
| R170S, A194P | | | | | | | |
| Y167A, R170N | nd | 0.8 | 4.7 | 4.9 | nd | 0.5 | 1.6 |
| Y167A, R170S, | nd | 0.6 | 1.7 | 5.3 | nd | 1.9 | nd |
| A172E | | | | | | | |
| N62D, Y167A, | nd | 0.8 | 3.0 | 6.6 | nd | 11.6 | nd |
| R170S, A194P | | | | | | | |
| N62D, R170S | nd | 0.6 | 4.3 | 7.4 | nd | 7.4 | nd |
| N62D, R170L | 0.6 | nd | 3.1 | 8.4 | nd | 9.4 | nd |
| *97aN, A98T, S99D | 0.6 | nd | 3.4 | 7.3 | nd | 5.5 | nd |
| *98aA, S99D, | nd | nd | 4.3 | 5.8 | nd | 6.9 | nd |
| N261D, | | | | | | | |
| L262Q | | | | | | | |

TABLE 7b
Wash performance at 20° C. of protease variants that have the
same amino acid sequence as SEQ ID NO: 1 except for the
substitutions as per the table below on the stains as indicated;
reference is the protease according to SEQ ID NO: 1.

| | A | B | C | D | E | F | G |
|---|---|---|---|---|---|---|---|
| *99aE, A194P | 0.5 | nd | 3.1 | nd | 2.0 | 3.4 | 0.6 |
| N76D, Y167A, | 2.0 | 3.5 | 2.6 | 3.6 | 0.5 | 2.2 | nd |
| R1705, A194P | | | | | | | |
| N76D, Y167A, | 2.9 | 3.3 | 2.7 | 4.5 | 1.0 | 0.8 | nd |
| R170S, A194P, | | | | | | | |
| A228V, A230V | | | | | | | |
| *99aE, S256D | 2.3 | 2.4 | 1.9 | 4.0 | 1.6 | 4.6 | nd |
| L21D, *99aE | nd | 1.8 | nd | 4.4 | 2.2 | 4.7 | nd |
| N62D, Q245R, | 2.8 | 1.0 | 3.1 | 4.9 | nd | 1.1 | nd |
| R170S | | | | | | | |
| R170L, Q206E, | 2.5 | 1.8 | 2.3 | 2.9 | 1.8 | nd | nd |
| S57P | | | | | | | |
| A133P, Y167A, | 2.1 | 1.6 | 1.7 | 3.5 | 2.0 | nd | 0.8 |
| R170S, A194P | | | | | | | |
| S141N, Y167A, | nd | nd | nd | 3.3 | 2.3 | 1.0 | 0.7 |
| R170S, A194P | | | | | | | |
| Y167A, R170N | nd | 0.6 | nd | 3.0 | 2.4 | nd | 1.2 |
| Y167A, R170S, | 3.1 | 2.7 | 0.5 | 2.4 | 1.9 | nd | nd |
| A172E | | | | | | | |
| N62D, Y167A, | 2.8 | 5.6 | 2.7 | 4.3 | 2.0 | 2.5 | nd |
| R170S, A194P | | | | | | | |
| N62D, R170S | 2.1 | 0.5 | 1.9 | 4.6 | 1.0 | 0.7 | nd |
| N62D, R170L | 3.5 | 4.0 | 1.6 | 4.6 | nd | nd | nd |
| *97aN, A98T, | nd | nd | 2.2 | 4.2 | 1.5 | 4.8 | 1.1 |
| S99D | | | | | | | |
| *98aA, S99D, | nd | nd | 2.8 | 3.5 | nd | 4.9 | nd |
| N261D, L262Q | | | | | | | |

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A detergent composition comprising subtilase variants comprising a set of alterations selected from the group of:
(a) X167A+R170S+A194P and one or more substitutions selected from the group of X59D, X62D, X76D, X104T, X120D, X133P, X141N, X156D, X163G, X209W, X228V, X230V, X238E, X261D, and X262E;
(b) *99aE and one or more substitutions selected from the group of X21D, X59D, X101H, X120D, X156D, X163G, X194P, X195E, X209W, X238E, X256D, X261D, and X262E;
(c) X62D and one or more substitutions selected from the group of X101H, X104T, X156D, X163G, X170S, X170L, X209W, X238E, X245R and X262E;
(d) X62D+X245R+X248D and one or more substitutions selected from the group of X156D, X163G, X163K, X170S, X209W, and X262E;
(e) X170L, X170N, X170S and one or more substitutions selected from the group of X57P, X167A, X172E, X206E; and
(f) X99D and one or more substitutions selected from the group of *97aN, *98aA, X98T, X261D, and X262Q;
wherein
(i) the positions correspond to the positions of the polypeptide of SEQ ID NO: 2;
(ii) the variant has protease activity; and
(iii) the variant has at least 60%, but less than 100% sequence identity to the polypeptide of SEQ ID NO: 1.

2. The detergent composition of claim 1, wherein the subtilase variant
comprises the alterations X167A+R170S+A194P and one or more substitutions selected from the group of X59D, X62D, X76D, X104T, X120D, X133P, X141N, X156D, X163G, X209W, X228V, X230V, X238E, X261D, and X262E.

3. The detergent composition of claim 1, wherein the subtilase variant comprises the alteration *99aE and one or more substitutions selected from the group of X21D, X59D, X101H, X120D, X156D, X163G, X194P, X195E, X209W, X238E, X256D, X261D, and X262E.

4. The detergent composition of claim 1, wherein the subtilase variant comprises the alteration X62D and one or more substitutions selected from the group of X101H, X104T, X156D, X163G, X170S, X170L, X209W, X238E, X245R and X262E.

5. The detergent composition of claim 1, wherein the subtilase variant comprises the alteration X62D+X245R+X248D and one or more substitutions selected from the group of X156D, X163G, X163K, X170S, X209W, and X262E.

6. The detergent composition of claim 1, wherein the subtilase variant comprises the alteration X170L, X170N, X170S and one or more substitutions selected from the group of X57P, X167A, X172E, and X206E.

7. The detergent composition of claim 1, wherein the subtilase variant comprises the alteration X99D and one or more substitutions selected from the group of *97aN, *98aA, X98T, X261D, and X262Q.

8. The detergent composition of claim 1, wherein the subtilase variant further comprises one or more alterations selected from the group of X3T, X4I, X9C, X9D, X9E, X9Q, X14T, X24G, X24R, X27R, *36D, X43A, X43C, X43L X43R, X43W, X68A, X72A, X72V, X76D, X78D, X87R, X87S, *97E, X98S, X99A, X99D, X99A, X99D, X99E, X99G, *99D, X101D, X101E, X101G, X101I, X101K, X101L, X101M, X101N, X101R, X103A, X104F, X104I, X104N, X104Y, X106A, X114V, X115T, X115W, X118R, X118V, X120D, X120I, X120N, X120T, X120V, X123S, X128A, X128L, X128S, X129D, X129N, X129Q, X130A, X147W, X149C, X149N, X158E, X160D, X160P, X161C, X161E, X162L, X163A, X163D, X182C, X182E, X185C, X185E, X188C, X188D, X188E, X191N, X195E, X199M, X204D, X204V, X205I, X206C, X206E, X206I, X206K, X206L, X206T, X206V, X206W, X209W, X212A, X212D, X212G, X212N, X216I, X216T, X216V, X217C, X217D, X217E, X217M, X217Q, X217Y, X218D, X218E, X218T, X222C, X222R, X222S, X225A, X232V, X235L, X236H, X245K, X245R, X252K, X255C, X255E, X256A, X256C, X256D, X256V, X256Y, X259D, X260E, X260P, X261C, X261E, X261F, X261L, X261M, X261V, X261W, X261Y, X262C, X262E, X262Q, and X274A, wherein each position corresponds to the position of the polypeptide of SEQ ID NO: 2.

9. The detergent composition of claim 1, wherein the subtilase variant comprises a set of alterations selected from the group of:
*99aE+A194P;
N76D+Y167A+R170S+A194P;
N76D+Y167A+R170S+A194P+A228V+A230V;
*99aE+S256D;
L21D+*99aE;
N62D+Q245R+R170S;
R170L+Q206E+S57P;
A133P+Y167A+R170S+A194P;
S141N+Y167A+R170S+A194P;
Y167A+R170N;
Y167A+R170S+A172E;
N62D+Y167A+R170S+A194P;
N62D+R170S;
N62D+R170L;
97aN+A98T+S99D;
98aA+S99D+N261D+L262Q;
Q59D+N76D+Y167A+R170S+A194P;
Q59D+*99aE+Y209W+L262E;
Q59D+Y167A+R170S+A194P+Y209W+L262E;
Q59D+Y167A+R170S+A194P+L262E;
N62D+S101H+R170S+Y209W+L262E;
N62D+V104T+S156D+R170S+Y209W+L262E;
N62D+V104T+R170S+Y209W+L262E;
N62D+S156D+S163G+Y209W+Q245R+N248D+L262E;
N62D+S156D+S163G+Y209W+L262E;
N62D+S156D+S163K+Y209W+Q245R+N248D+L262E;
N62D+S156D+R170S+Y209W+L262E;
N62D+R170S+Y209W+Q245R+N248D+L262E;
N62D+R170S+Y209W+L262E;
N62D+R170S+N238E+L262E;
N76D+Y167A+R170S+A194P+N238E;
*99aE+S101H+H120D+S163G+N261D;
*99aE+S156D+Y209W+L262E;
*99aE+B194P+G195E+Y209W+L262E;
*99aE+B194P+G195E+L262E;
*99aE+N238E+L262E;
V104T+H120D+S163G+Y167A+R170S+A194P+N261D;
V104T+S156D+Y167A+R170S+A194P+Y209W+L262E;
V104T+Y167A+R170S+A194P+Y209W+N238E+L262E; and
V104T+Y167A+R170S+A194P+N238E+L262E.

10. The detergent composition of claim 1, wherein the subtilase variant is a variant of subtilisin 309 (SEQ ID NO: 1) or subtilisin BPN′ (SEQ ID NO: 2) comprising the set of alterations.

11. The detergent composition according to claim 1, wherein the detergent composition comprising the subtilase variant exhibits improved wash performance as compared to a detergent composition comprising a subtilase having SEQ ID NO: 1 when measured in AMSA assay.

12. The detergent composition of claim 1, wherein the total number of alterations in the subtilase variant as compared to SEQ ID NO: 1 is between 3 and 30.

13. The detergent composition of claim 1, wherein the composition is in form of a bar, a homogenous tablet, a tablet having two or more layers, a pouch having one or more compartments, a regular or compact powder, a granule, a paste, a gel, or a regular, compact or concentrated liquid.

14. The detergent composition of claim 1, wherein the composition further comprises one or more additional enzymes selected among protease, lipase, cutinase, amylase, carbohydrase, cellulase, pectinase, mannanase, arabinase, galactanase, xylanase, oxidase, xanthanase, laccase, and/or peroxidase.

15. The detergent composition of claim 1, wherein the composition is a laundry detergent composition or a dishwashing composition.

16. The use of a detergent composition of claim 1, wherein the detergent composition is utilized in a cleaning process.

17. The detergent composition of claim 16, wherein the cleaning process is laundry or hard surface cleaning.

18. A method for removing a stain from a surface, the method comprising contacting the surface with a detergent composition according to claim 1.


SEQUENCE LISTING (11 sequences)

SEQ ID NO: 1 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 2 - protein, 275 aa, Bacillus amyloliquefaciens [sequence omitted]

SEQ ID NO: 3 - protein, 275 aa, Bacillus subtilis 168
AQSVPYGISQIKAPALHSQGYTGSNVKVAVIDSGIDSSHPDLNVRGGASFVPSETNPYQDGSSHGTHVAGTIAALNNSIGVLGVSPSASLYAVKVLDSTGSGQYSWIINGIEWAISNNMDVINMSLGGPTGSTALKTVVDKAVSSGIVVAAAAGNEGSSGSTSTVGYPAKYPSTIAVGAVNSSNQRASFSSAGSELDVMAPGVSIQSTLPGGTYGAYNGTSMATPHVAGAAALILSKHPTWTNAQVRDRLESTATYLGNSFYYGKGLINVQAAAQ

SEQ ID NO: 4 - protein, 274 aa, Bacillus subtilis DY
AQTVPYGIPLIKADKVQAQGYKGANVKVGIIDTGIAASHTDLKVVGGASFVSGESYNTDGNGHGTHVAGTVAALDNTTGVLGVAPNVSLYAIKVLNSSGSGTYSAIVSGIEWATQNGLDVINMSLGGPSGSTALKQAVDKAYASGIVVVAAAGNSGSSGSQNTIGYPAKYDSVIAVGAVDSNKNRASFSSVGAELEVMAPGVSVYSTYPSNTYTSLNGTSMASPHVAGAAALILSKYPTLSASQVRNRLSSTATNLGDSFYYGKGLINVEAAAQ

SEQ ID NO: 5 - protein, 274 aa, Bacillus licheniformis
AQTVPYGIPLIKADKVQAQGFKGANVKVAVLDTGIQASHPDLNVVGGASFVAGEAYNTDGNGHGTHVAGTVAALDNTTGVLGVAPSVSLYAVKVLNSSGSGTYSGIVSGIEWATTNGMDVINMSLGGPSGSTAMKQAVDNAYARGVVVVAAAGNSGSSGNTNTIGYPAKYDSVIAVGAVDSNSNRASFSSVGAELEVMAPGAGVYSTYPTSTYATLNGTSMASPHVAGAAALILSKHPNLSASQVRNRLSSTATYLGSSFYYGKGLINVEAAAQ

SEQ ID NO: 6 - protein, 268 aa, Bacillus lentus
QTVPWGISFINTQQAHNRGIFGNGARVAVLDTGIASHPDLRIAGGASFISSEPSYHDNNGHGTHVAGTIAALNNSIGVLGVRPSADLYALKVLDRNGSGSLASVAQGIEWAINNNMHIINMSLGSTSGSSTLELAVNRANNAGILLVGAAGNTGRQGVNYPARYSGVMAVAAVDQNGQRASFSTYGPEIEISAPGVNVNSTYTGNRYVSLSGTSMATPHVAGVAALVKSRYPSYTNNQIRQRINQTATYLGSPSLYGNGLVHAGRATQ

SEQ ID NO: 7 - protein, 269 aa, Bacillus alcalophilus PB92
AQSVPWGISRVQAPAAHNRGLTGSGVKVAVLDTGISTHPDLNIRGGASFVPGEPSTQDGNGHGTHVAGTIAALNNSIGVLGVAPNAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 8 - protein, 268 aa, Bacillus YaB
QTVPWGINRVQAPIAQSRGFTGTGVRVAVLDTGISNHADLRIRGGASFVPGEPNISDGNGHGTQVAGTIAALNNSIGVLGVAPNVDLYGVKVLGASGSGSISGIAQGLQWAANNGMHIANMSLGSSAGSATMEQAVNQATASGVLVVAASGNSGAGNVGFPARYANAMAVGATDQNNNRATFSQYGAGLDIVAPGVGVQSTVPGNGYASFNGTSMATPHVAGVAALVKQKNPSWSNVQIRNHLKNTATNLGNTTQFGSGLVNAEAATR

SEQ ID NO: 9 - protein, 272 aa, Bacillus sp. NKS-21
QTVPWGIPYIYSDVVHRQGYFGNGVKVAVLDTGVAPHPDLHIRGGVSFISTENTYVDYNGHGTHVAGTVAALNNSYGVLGVAPGAELYAVKVLDRNGSGSHASIAQGIEWAMNNGMDIANMSLGSPSGSTTLQLAADRARNAGVLLIGAAGNSGQQGGSNNMGYPARYASVMAVGAVDQNGNRANFSSYGSELEIMAPGVNINSTYLNNGYRSLNGTSMASPHVAGVAALVKQKHPHLTAAQIRNRMNQTAIPLGNSTYYGNGLVDAEYAAQ

SEQ ID NO: 10 - protein, 269 aa, Bacillus sp. G-825-6
NQVTPWGITRVQAPTAWTRGYTGTGVRVAVLDTGISTHPDLNIRGGVSFVPGEPSYQDGNGHGTHVAGTIAALNNSIGVVGVAPNAELYAVKVLGANGSGSVSSIAQGLQWTAQNNIHVANLSLGSPVGSQTLELAVNQATNAGVLVVAATGNNGSGTVSYPARYANALAVGATDQNNNRASFSQYGTGLNIVAPGVGIQSTYPGNRYASLSGTSMATPHVAGVAALVKQKNPSWSNTQIRQHLTSTATSLGNSNQFGSGLVNAEAATR

SEQ ID NO: 11 - protein, 279 aa, Thermoactinomyces vulgaris [sequence omitted]